(19) United States
(12) Patent Application Publication
(10) Pub. No.: US 2023/0351333 A1
(43) Pub. Date: Nov. 2, 2023

(54) INTEGRATED SOFTWARE-AS-A-SERVICE PLATFORM FOR SKILLS MANAGEMENT AND MATCHING

(71) Applicant: Ajna Software LLC, Lafayette, CA (US)

(72) Inventors: Sara MENKE, Moraga, CA (US); Matt RUPORT, Moraga, CA (US); Ana LEVAN, Moraga, CA (US); Kimberly HALLOWELL, Moraga, CA (US); Kailee BENTZ, Moraga, CA (US)

(21) Appl. No.: 18/310,421

(22) Filed: May 1, 2023

Related U.S. Application Data
(60) Provisional application No. 63/336,994, filed on Apr. 29, 2022.

(51) Int. Cl. G06Q 10/1053; G06N 3/044; G06F 40/279; G06F 40/47

(52) U.S. Cl. CPC G06Q 10/1053; G06N 3/044; G06F 40/279; G06F 40/47

(57) ABSTRACT

Methods and systems for skills management and matching are described. An example method for enabling client opportunities to be matched with candidates includes receiving, from a resume database, a resume associated with a candidate, processing, using a neural network, the resume to generate a plurality of skills and experiences, receiving a plurality of attributes associated with a work opportunity, creating a job listing by mapping the plurality of attributes to a plurality of requirements, each of the plurality of requirements being selected from a pool of job titles and job duties, computing, based on the job listing, a plurality of scores by performing a matching operation between the plurality of skills and experiences and the plurality of requirements, computing a weighted sum of the plurality of scores, and generating, based on the weighted sum, a decision indicative of an offer for an interview to the candidate for the work opportunity.

### CROSS-REFERENCE TO RELATED APPLICATION

This patent document claims the benefit of priority to U.S. Provisional Patent Application No. 63/336,994 filed on Apr. 29, 2022. The entire contents of the before-mentioned patent application are incorporated by reference as part of the disclosure of this application.

### TECHNICAL FIELD

This document generally relates to software-as-a-service (SaaS) application, and more particularly to an integrated SaaS application for matching candidates and employment opportunities.

### BACKGROUND

Companies want more diverse candidate pools, and diverse companies have plenty of advantages. The World Economic Forum reports up to a 20% increase in innovation and 19% in innovation revenue from greater diversity efforts. Other benefits include greater employee engagement, strong decision-making ability, and heightened profitability.

However, the unconscious hampers the recruitment process. In the hiring process, unconscious bias happens when you form an opinion about candidates based solely on first impressions. Even in the early hiring stages, a candidate's resume picture, their name, or their hometown could influence your opinion more than you think. In short, unconscious bias influences your decision—whether positively or negatively—using criteria irrelevant to the job.

### SUMMARY

Embodiments of the disclosed technology relate to software-as-a-service (SaaS) platforms that enable the matching of candidates and employment opportunities without needing to rework a resume for every different job, and allows matching in industries that may not have been previously considered by the candidates. In an example, this is achieved translating the resume into a universal language, thereby generating a profile for a candidate that is matched to jobs that need experience that the candidate has, and which matches the candidate's requirements. Furthermore, the described embodiments advantageously gate (or redact) certain candidate information to eliminate biases that exist in current hiring practices.

In an example, a system for skills management and matching includes a graphical user interface, a neural network, a universal language processor, a weight generation module, and a matching engine. The neural network comprises an input that receives a resume associated with a candidate, and is configured to process the resume to extract a plurality of skills and experiences reflective of one or more capabilities of the candidate. The universal language processor comprises an input that receives a plurality of attributes associated with a work opportunity, and is configured to create a job listing by mapping the plurality of attributes to a plurality of requirements, such that each of the plurality of requirements is selected from a pool of job titles and job duties. The weight generation module is configured to generate a plurality of weights. The matching engine comprises a first input, coupled to an output of the neural network, that receives the plurality of skills and experiences, a second input, coupled to an output of the weight generation module, that receives the plurality of weights, a third input, coupled to an output of the universal language processor, that receives the plurality of requirements, and an output, coupled to the graphical user interface, that outputs, for display on the graphical user interface, a decision to extend an offer for an interview to the candidate for the work opportunity. The matching engine is configured to compute a plurality of scores by performing a matching operation between the plurality of skills and experiences and the plurality of requirements, compute a weighted sum by multiplying each of the plurality of weights to a corresponding each of the plurality of scores, and generate, based on the weighted sum, the decision.

In another example, a method for skills management and matching includes receiving a resume associated with a candidate and a plurality of attributes associated with a work opportunity. The method further includes processing, using a neural network, the resume to generate a plurality of skills and experiences, and then creating a job listing by mapping the plurality of attributes to a plurality of requirements. Herein, each of the plurality of requirements is selected from a pool of job titles and job duties. The method then includes computing, based on the job listing, a plurality of scores by performing a matching operation between the plurality of skills and experiences and the plurality of requirements, computing a weighted sum of the plurality of scores, and generating, based on the weighted sum, a decision indicative of an offer for an interview to the candidate for the work opportunity.

In yet another example, the above-described method may be implemented by an apparatus or device that comprises a processor and/or memory.

In yet another example, this method may be embodied in the form of processor-executable instructions and stored on a computer-readable program medium.

The subject matter described in this patent document can be implemented in specific ways that provide one or more of the following features.

### BRIEF DESCRIPTION OF DRAWINGS

FIGS. 1A-1D illustrate example screenshots of an administrator portal used to create new job listing in a software platform for skills management and matching.

FIGS. 2A-2C illustrate example screenshots of an administrator portal used to track information for a particular candidate.

FIGS. 3A-3D illustrate example screenshots of an administrator portal used to track information for a particular job.

FIG. 4 illustrates an example screenshot of an administrator portal used to track the interviews that a candidate has scheduled.

FIGS. 5A-5D illustrate example screenshots of a software platform candidate portal.

FIGS. 6A-6E illustrate example screenshots of a software platform client portal.

FIG. 7 illustrates an example deployment architecture of a software platform for skills management and matching.

FIG. 8 illustrates an example system architecture of a software platform.

FIG. 9 is a flowchart illustrating example operations of the software platform.

FIGS. 10A-10J illustrate example screenshots of an administrator portal for a software-as-a-service (SaaS) platform for skills management and matching.

FIGS. 11A-11F illustrate example screenshots of a SaaS platform candidate portal.

FIGS. 12A-12H illustrate example screenshots of a SaaS platform client portal.

FIG. 13 illustrates an example deployment architecture of a SaaS platform.

FIG. 14 an example backend system architecture of a SaaS platform.

FIG. 15 is a flowchart illustrating example operations of the SaaS platform.

FIGS. 16A-16M illustrate examples of determining scores for different skills being matched with different job requirements for job to candidate matching.

FIGS. 17A-17G illustrate examples of determining scores for different skills being matched with different job requirements for candidate to job matching.

FIG. 18 is a block diagram illustrating an example of the functional architecture of a software/SaaS platform for skills management and matching.

FIG. 19 is a flowchart of an example method for skills management and matching.

FIG. 20 illustrates a block diagram of an example embodiment of a device that implements the disclosed technology.

### DETAILED DESCRIPTION

Embodiments of the disclosed technology are directed to eliminating bias from the recruiting process with defined parameters for matching, gated content, talent, and job profiles. No resume or job description is required because the described embodiments use globally recognized job-based parameters and AI-integrated parsing, which results in talent at all levels of hiring being matched to new job opportunities based on skills, qualifications, and experience.

Embodiments of the disclosed technology provide, inter alia, the following technical solutions that advantageously enable skills management and matching:
Creating a job listing from a universal language pool of job titles and job duties, which ensures that any inherent bias is mitigated in the job listing;
Using a neural network (which includes natural language processing (NLP)) to extract skills and experiences from a candidate resume;
Gating (or redacting) a portion of the candidate's resume for the initial stages of the job matching and interviewing process;
Computing a score for each of a set of job requirements and features; and
Making a hiring decision (e.g., setting up an interview with the candidate) based on a weighted sum of the scores for each of the set of job requirements and features.

Section headings are used in the present document to improve readability of the description and do not in any way limit the discussion or the embodiments to the respective sections only.

1 Example Embodiments of the Software Platform

In some embodiments, the described technology can be implemented as a software platform that provide skills management and matching between employers and job seekers. In an example, the software platform includes a graphical user interface (described in Section 1.1), which is a front-end for the platform architecture (described in Section 1.2), which enables job-based parameters and AI-integrated parsing to be used to match available jobs with qualified candidates in an unbiased manner.

1.1 GUI for the Software Platform

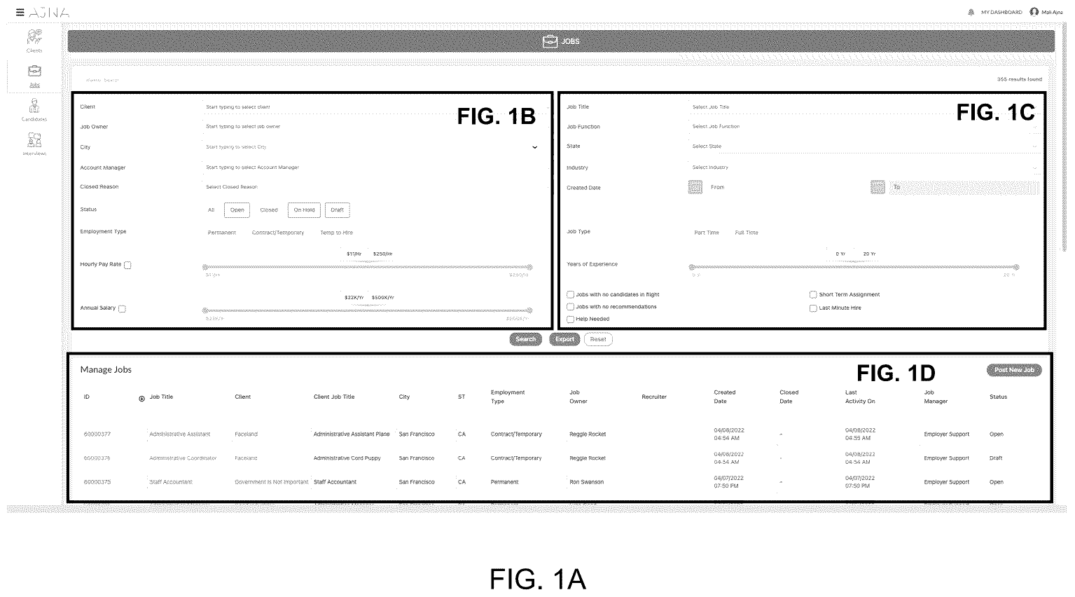

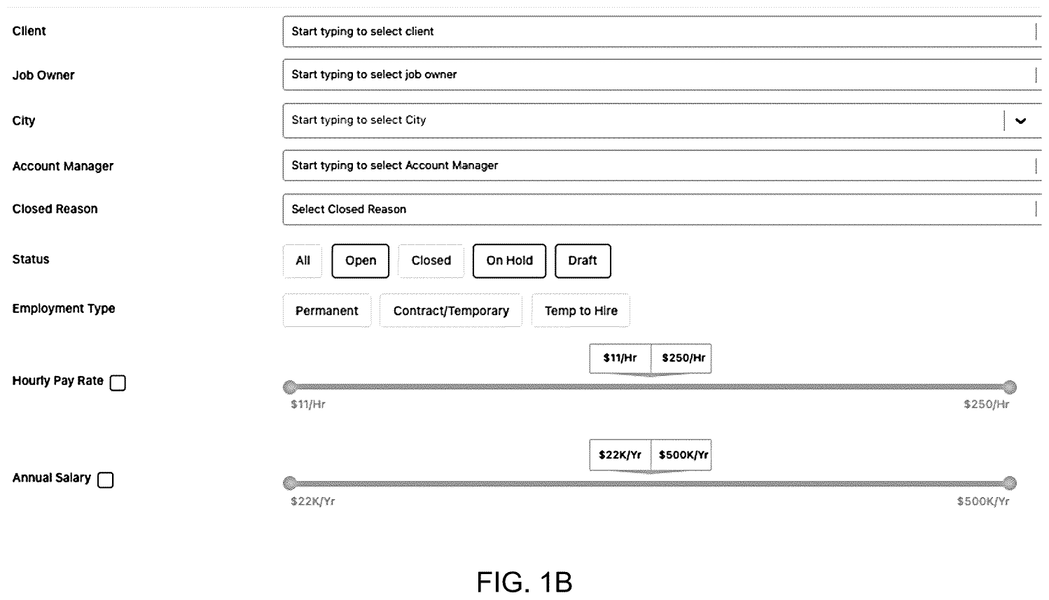

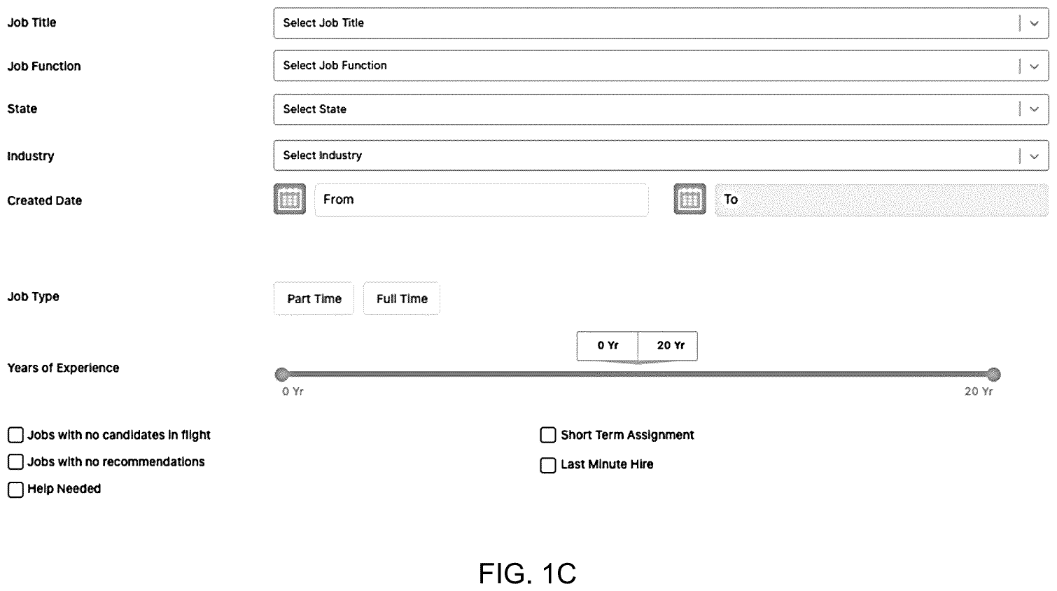

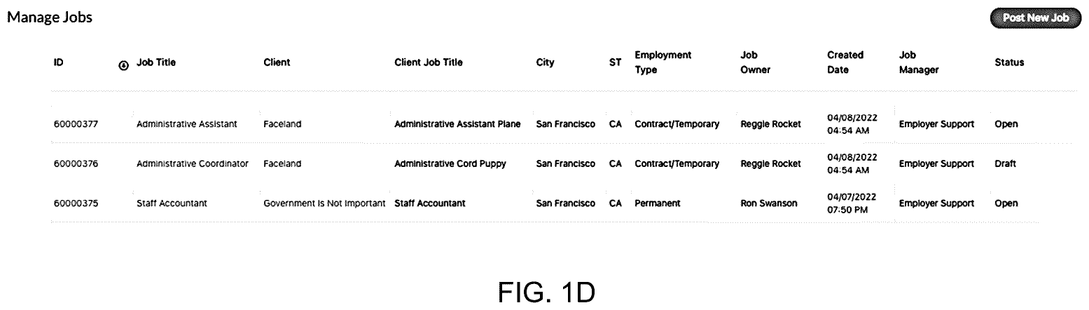

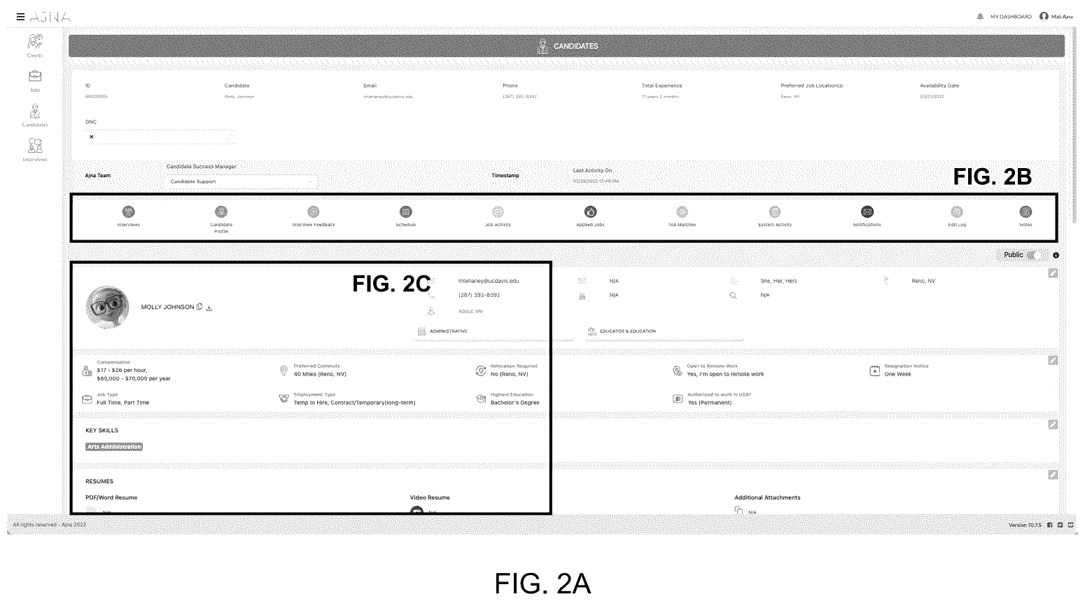

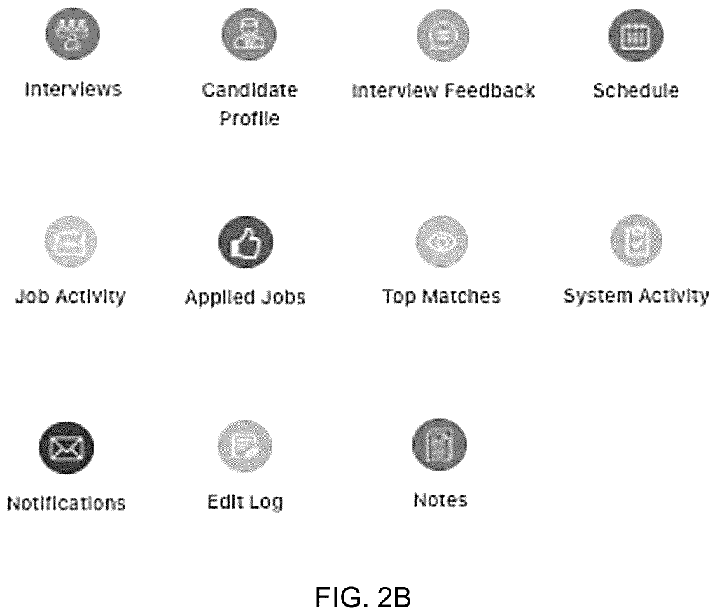

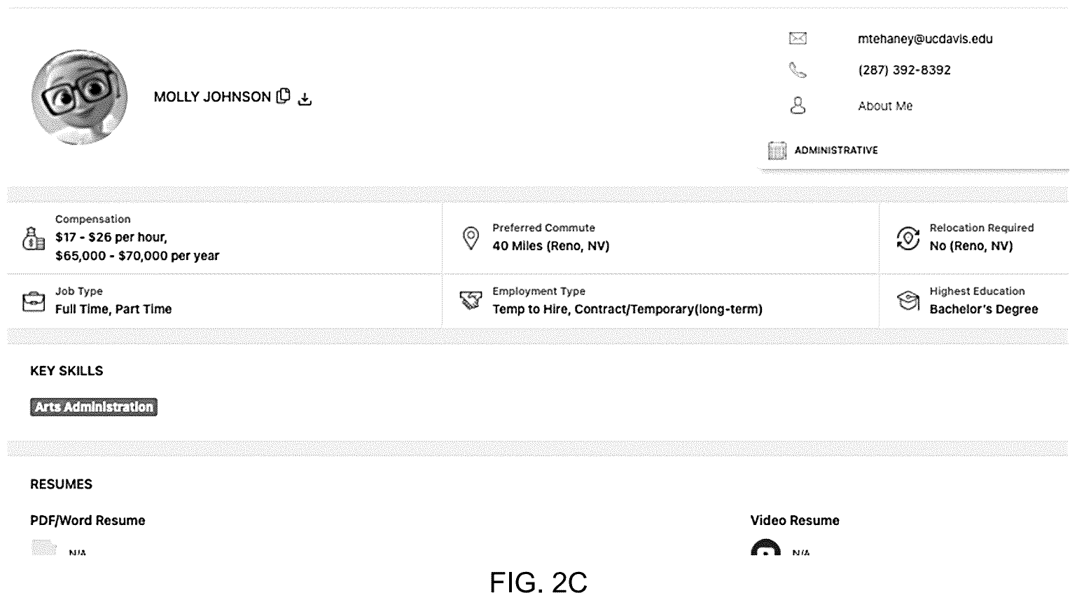

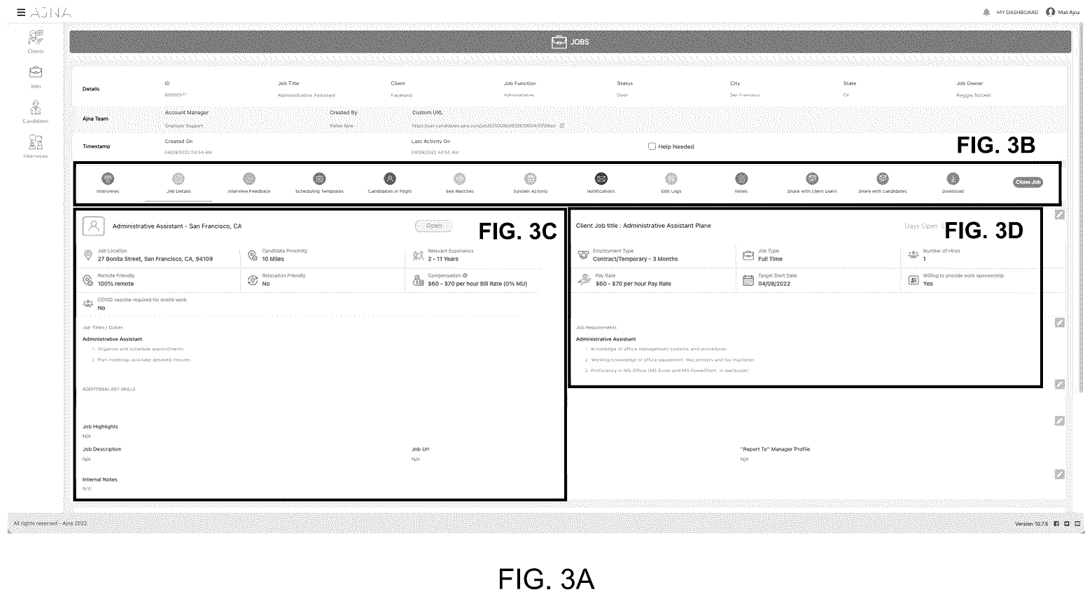

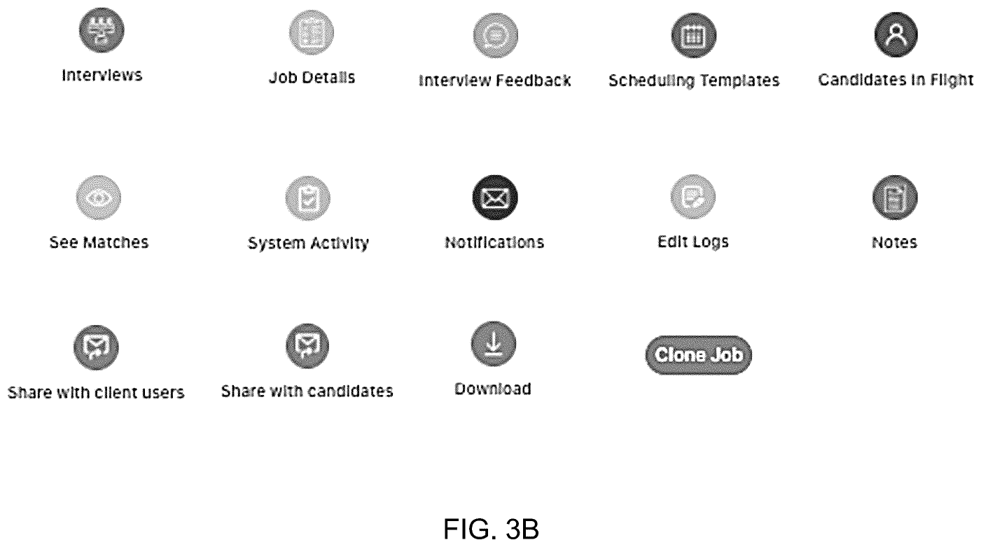

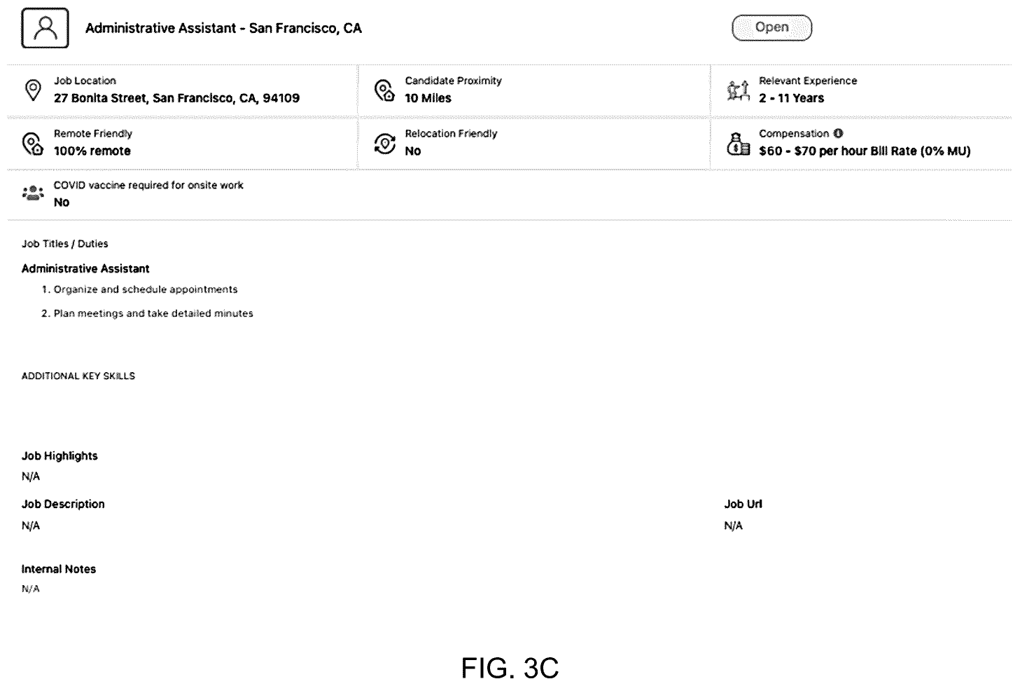

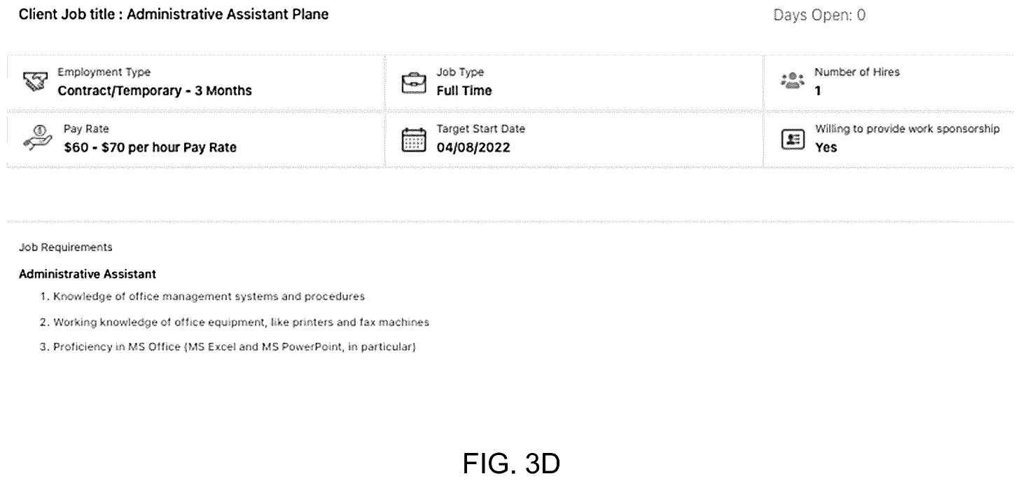

In some embodiments, the graphical user interface (GUI) for the software platform can be distinctly configured for administrators, candidates (e.g., job seekers), and clients (e.g., employers). FIGS. 1A-1D, 2A-2C, 3A-3D and 4 illustrate example screenshots of an administrator portal for a software platform for skills management and matching. The administrator portal can be used to track all the available jobs on the platform and create new job listings (see FIGS. 1A-1D), track information for a particular candidate (see FIG. 2A-2C), track information for a particular job (see FIG. 3A-3D), and track any interviews that a candidate has scheduled for a particular job (see FIG. 4).

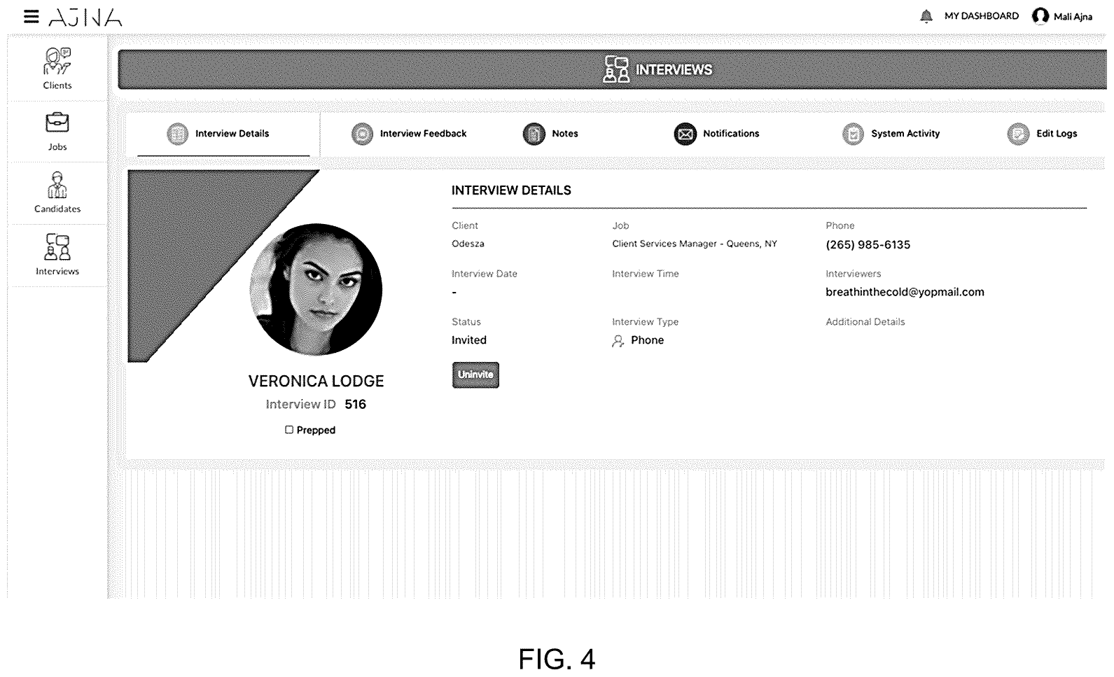

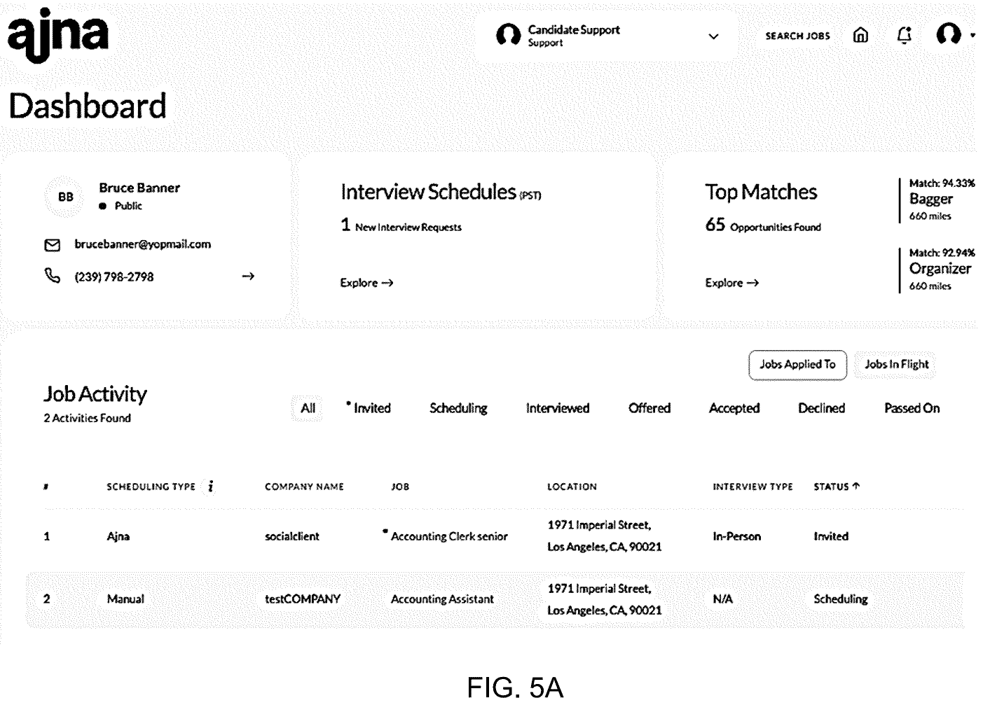

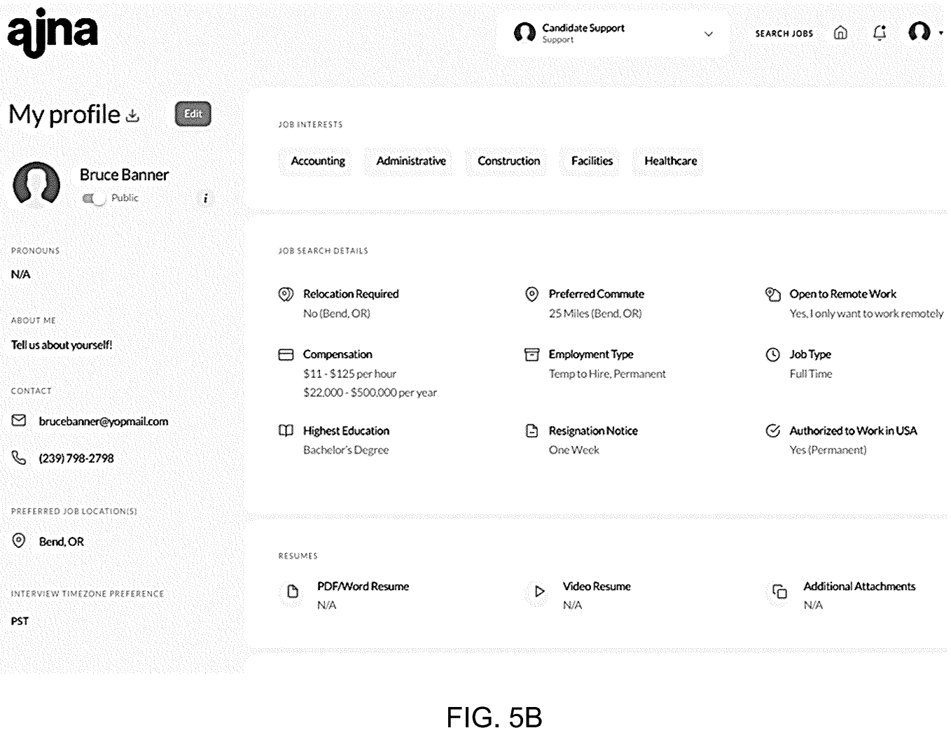

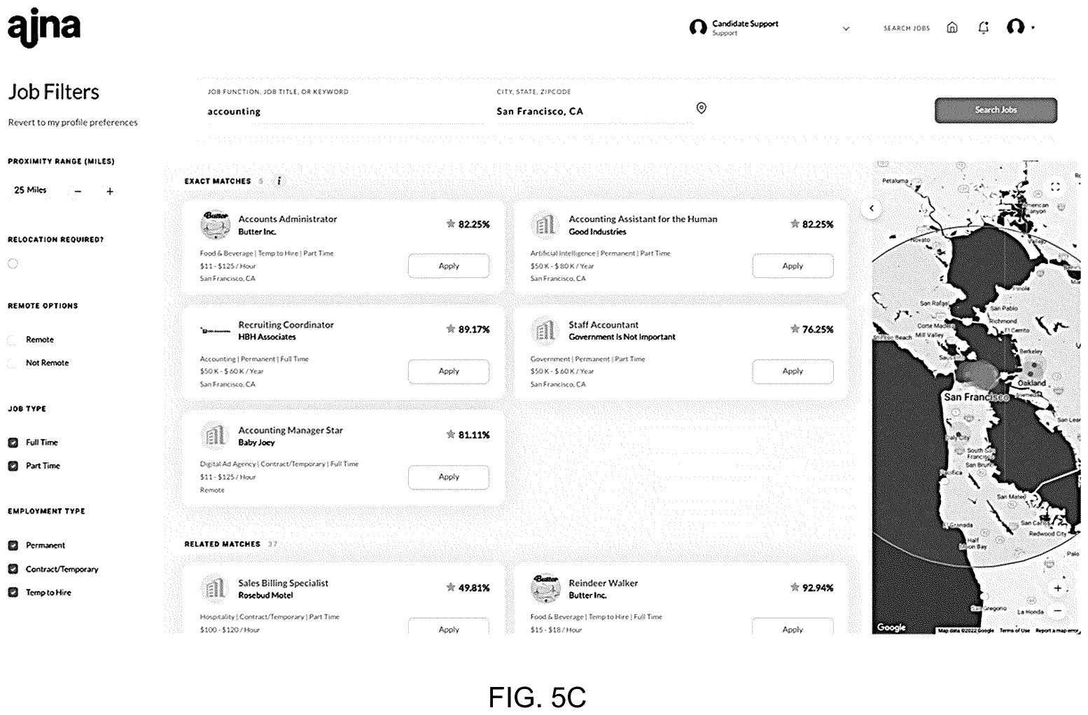

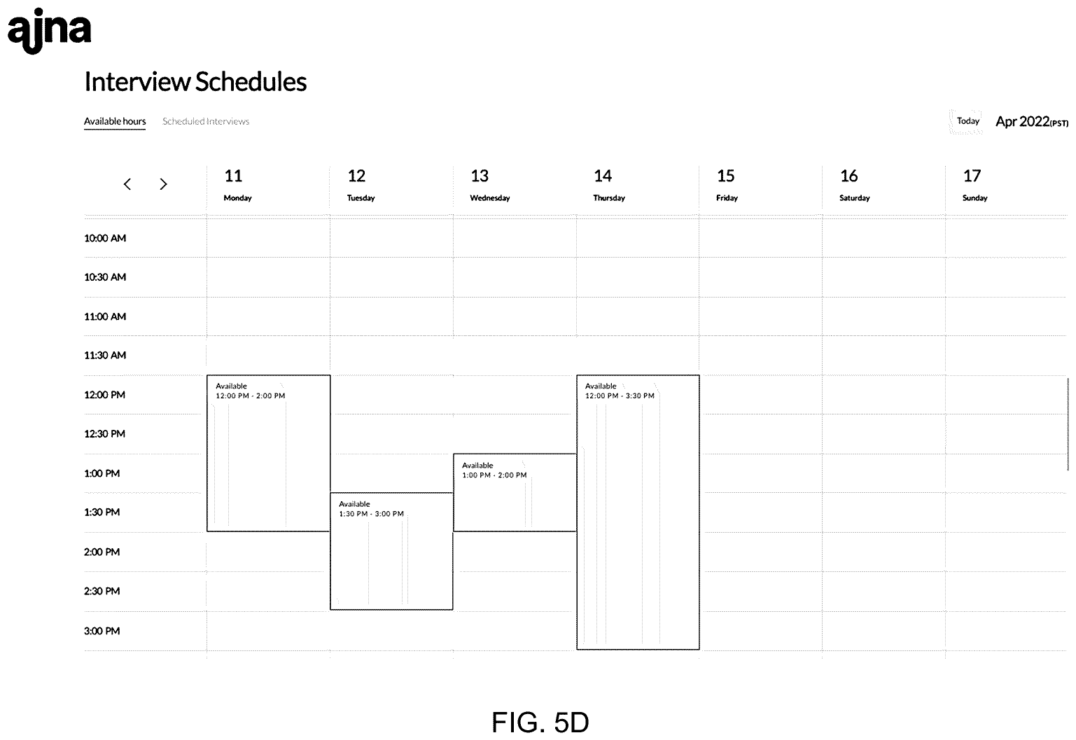

FIGS. 5A-5D illustrate example screenshots of a candidate portal for a software platform for skills management and matching. A candidate using the candidate portal typically starts at the dashboard (see FIG. 5A), through which the candidate can manage his/her profile (see FIG. 5B), search and filter available jobs (see FIG. 5C), and view an interview schedule (see FIG. 5D). In some embodiments, the candidate can create an independent account for the platform or log in using an existing account (e.g., Google, Facebook, or Apple ID). In other embodiments, the candidate can using single sign-on (SSO) authentication to log into the platform.

In some embodiments, available jobs can be searched using “Job Function, Job Title, or Keyword” and can be filtered using “City, State, Zipcode, or Remote.” The software platform is configured generate matches using the matching algorithm detailed in Section 3.2, and will return both Exact Matches (in which each of the candidate criteria match the job requirements) and Related Matches (e.g., in which the Job Function might not be an identical match, but would be within the same Job Family).

In some embodiments, an interview schedule can be generated using the candidate's preferred times or the employer's preferred times, and upon confirmation, the particular job listing would be moved to the “Jobs in Flight” section of the candidate portal. The candidate has the ability to drop out of the interview, and the software platform is then configured to request feedback from the candidate as to why the candidate did not want to pursue this job opportunity.

In some embodiments, the candidate can convert his/her profile into a resume, which can be downloaded in a PDF format or a word processor format (e.g., Microsoft Word). The resume that is downloaded can be selectively redacted to reduce inherent biases (as described in Section 3.1), and can be tailored for any stage of the search process using the customization options available through the dashboard.

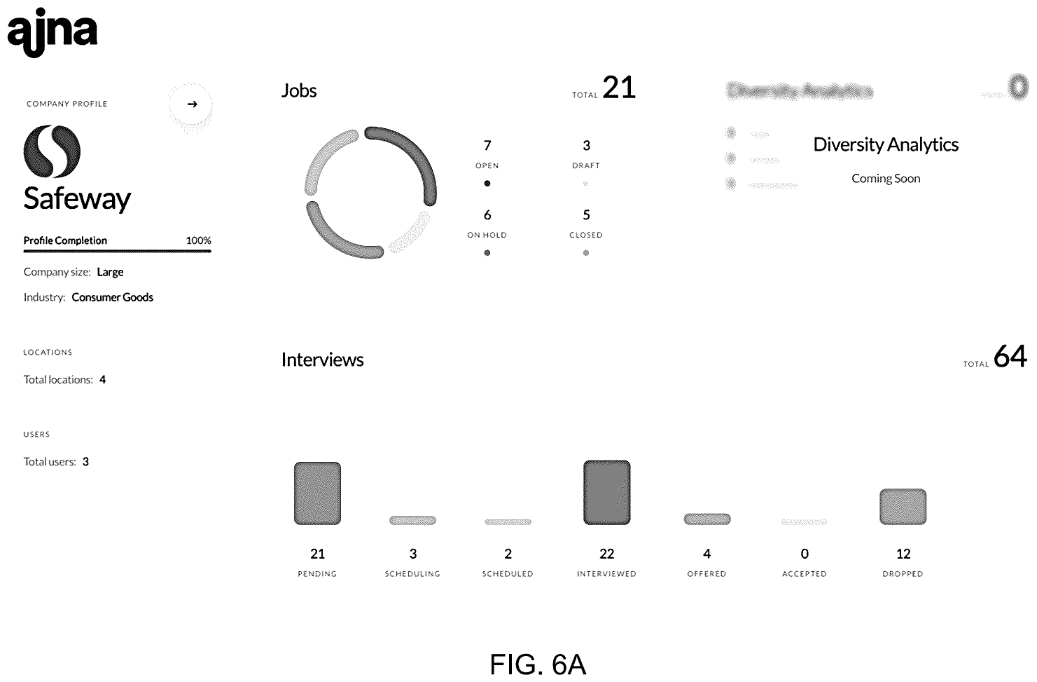

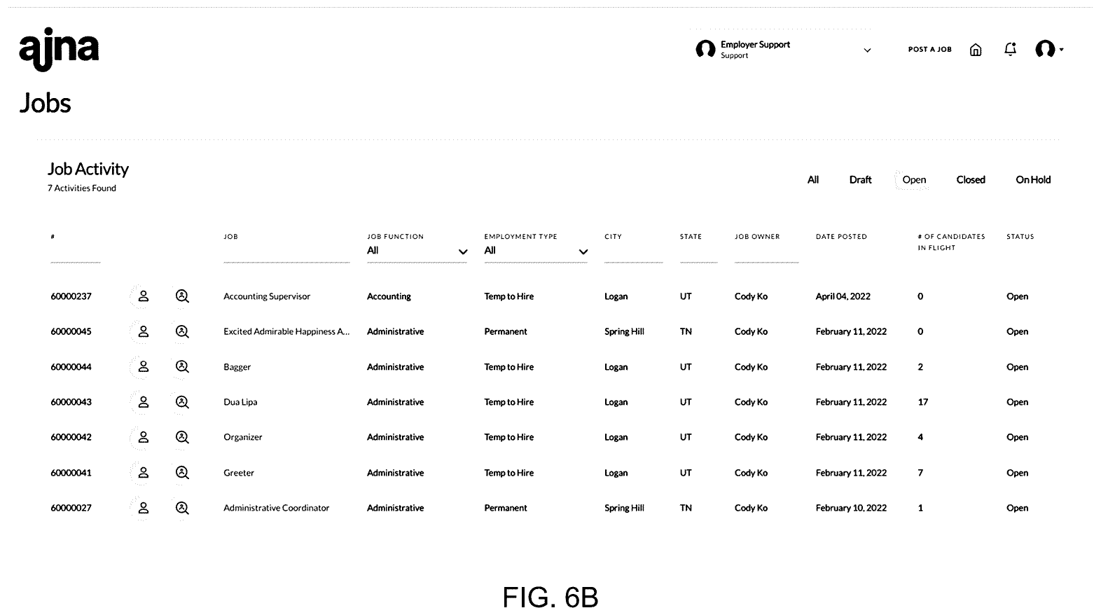

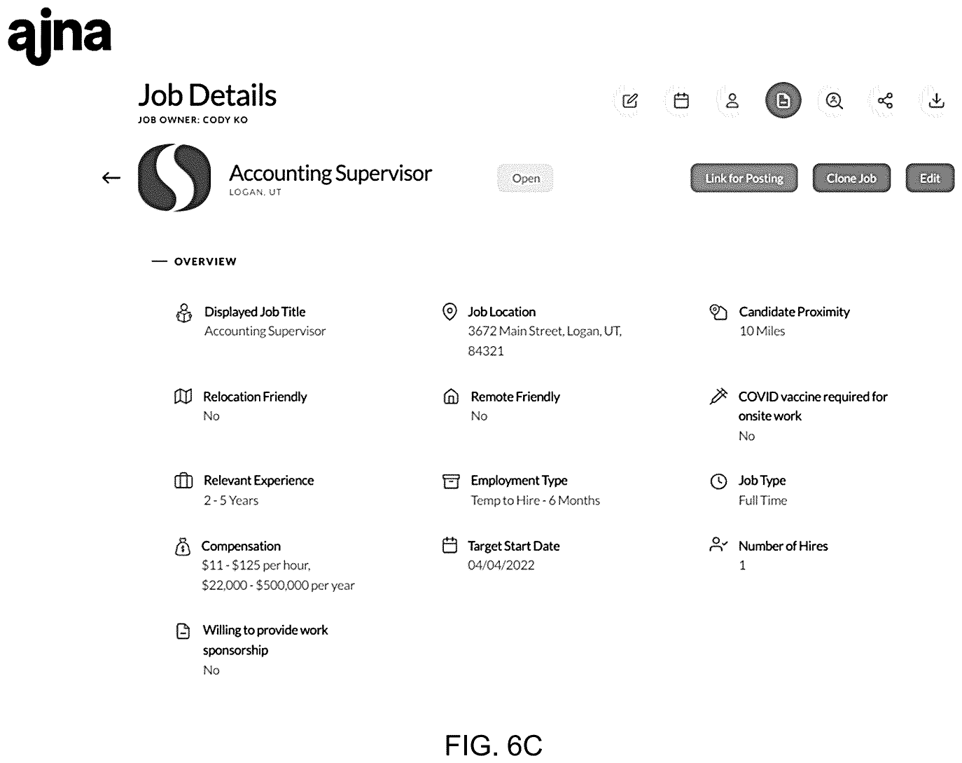

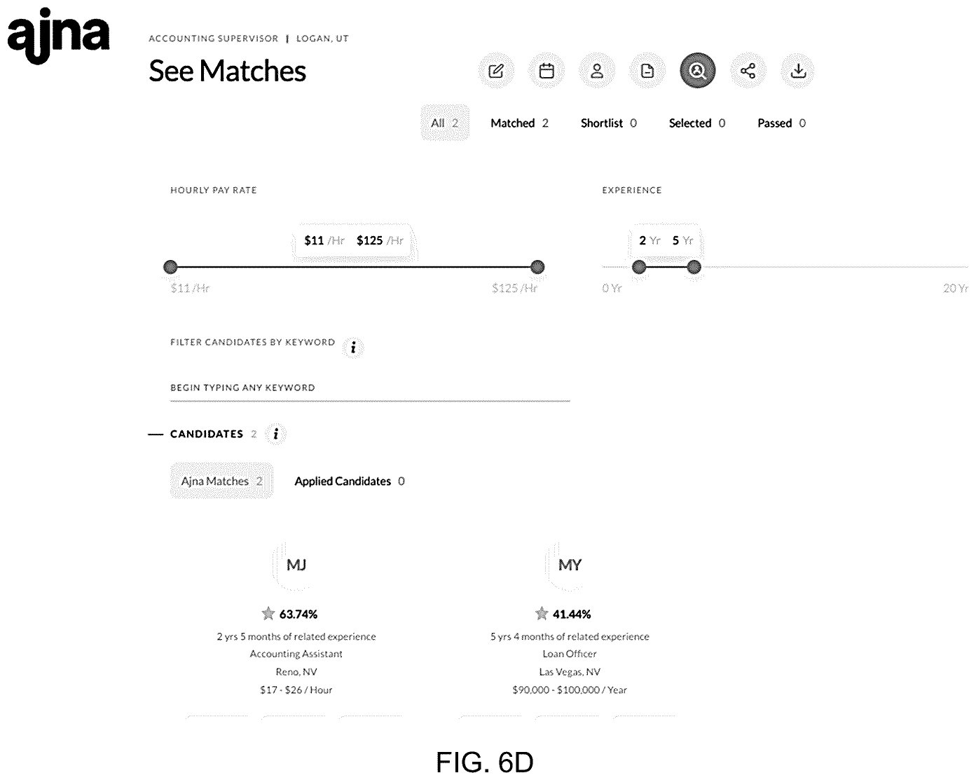

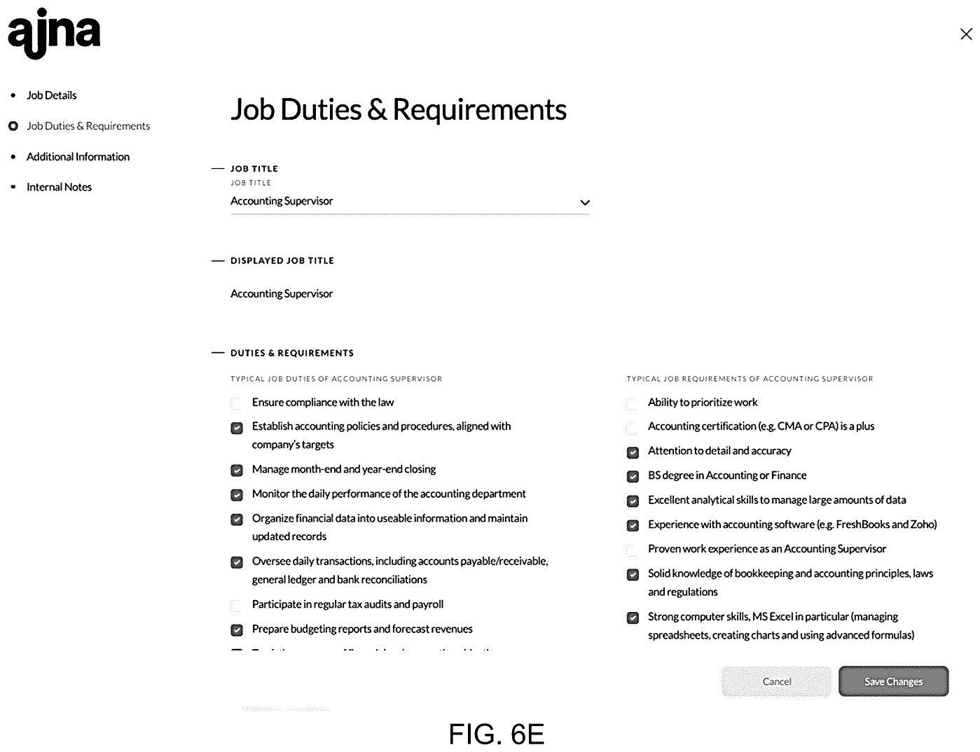

FIGS. 6A-6E illustrate example screenshots of a client portal for a software platform for skills management and matching. A client using the client portal typically starts at the dashboard (see FIG. 6A), which overviews the open jobs and scheduled interviews, and through which the client can view a list of available openings that the client currently has (see FIG. 6B), an overview of a particular job opening (see FIG. 6C), any candidate matches for the job opening (see FIG. 6D), and the duties and requirements for a particular job (see FIG. 6E).

In some embodiments, the employer can create a job listing by filling out basic job details (location options, job type, compensation, target start date, etc.) and then select from a pool of hundreds of universal job titles and job duties to build an unbiased job posting. Selecting from the pool of universal titles and duties advantageously ensures that the posted job listing will match actual skills and experiences that a larger pool of candidates bring to the table (instead of losing matches due to syntax mismatches and the like). The employer can also add differentiators associated with the particular job, such as flexible work hours, travel, perks, interest groups, mentoring, etc. The employer will also have the option of advertising the unbiased job listing that was just created through one or more of its social media channels.

In some embodiments, the clients viewing the candidates that are a match for a job can only view limited (or redacted) information to ensure an unbiased hiring process (as further described in Section 3.1). In other embodiments, the client can view all candidate information based on the profile preferences of the candidate.

1.2 Architecture for the Software Platform

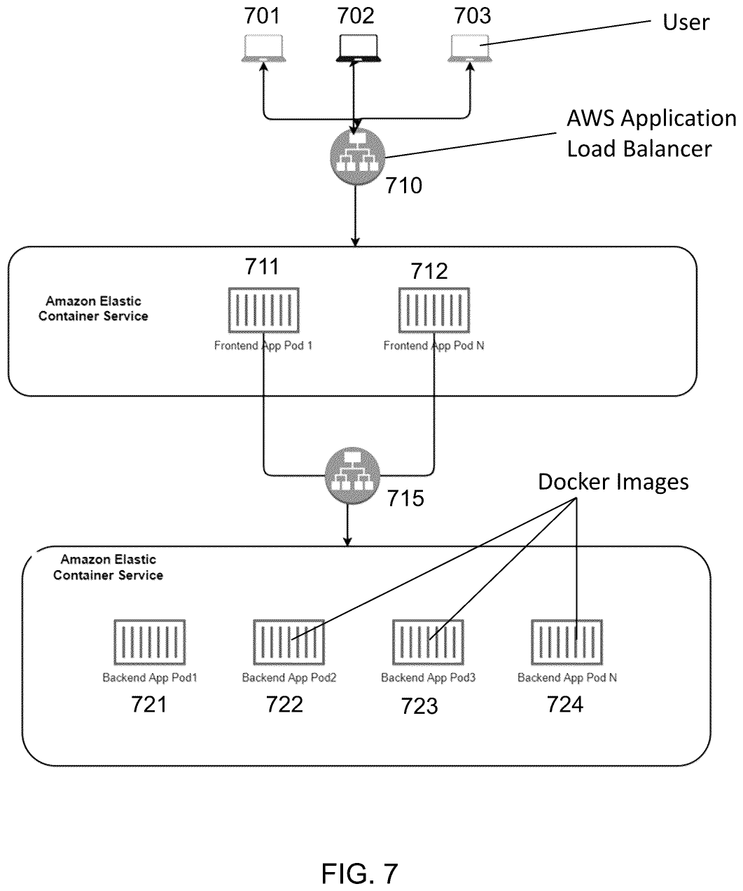

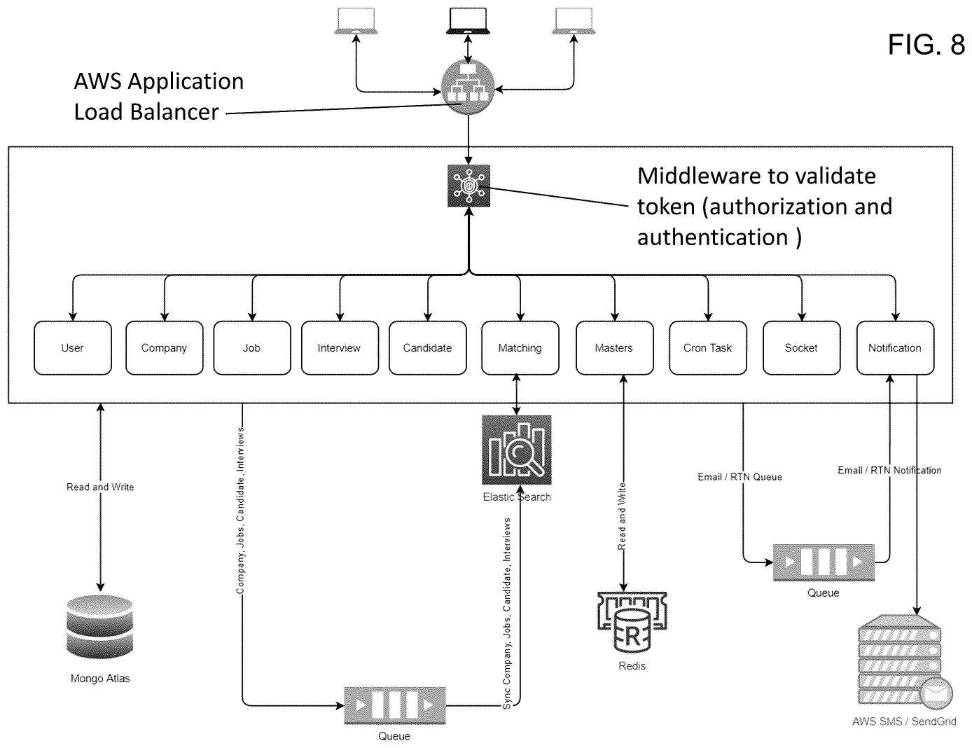

In some embodiments, the GUIs for the administrator portal, candidate portal, and client portal are deployed using the deployments and architectures illustrated in FIGS. 7 and 8.

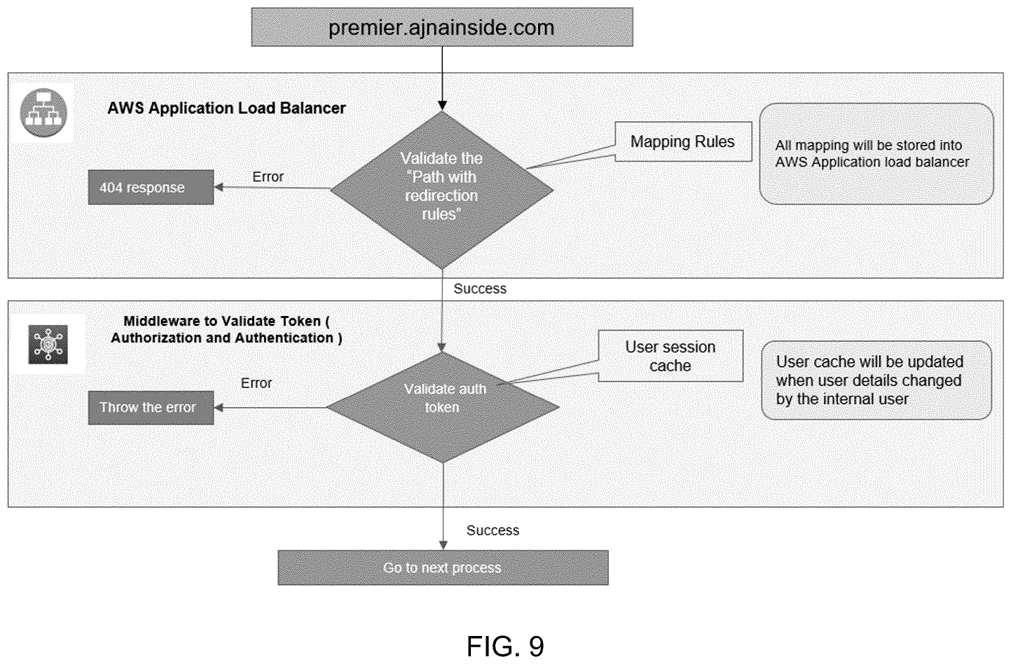

FIG. 7 illustrates an example deployment architecture of a software platform for skills management and matching. As shown therein, users (701-703) are connected to frontend instances (711-712) via a first load balancer (710), and the frontend instances (711, 712) are connected to backend instances (721-724) via another load balancer (715). In some embodiments, the frontend and backend instances are hosted on Amazon Web Services (AWS) with SSH certifications, two-factor authentication at first log in (OTP), and password encryption security. In some embodiments, routing rules are defined into the load balancer (as shown in FIG. 9) and autoscaling policies are implemented for both frontend and backend instances. FIG. 8 illustrates an example system architecture of a software platform for skills management and matching, and as shown therein, includes middleware to validate tokens for authorization and authentication (including the operations shown in FIG. 9).

2 Example Embodiments of the Software-as-a-Service (SaaS) Platform

In some embodiments, the described technology can be implemented as a software-as-a-service (SaaS) platform that provide skills management and matching between employers and job seekers. The SaaS platform is a cloud-based deployment of the software platform described in the previous section, and includes some features and/or aspects that are similar to those described in the context of the software platform in Section 1. At least some of these features and/or aspects may not be separately described as part of the examples in this section.

2.1 GUI for the SaaS Platform

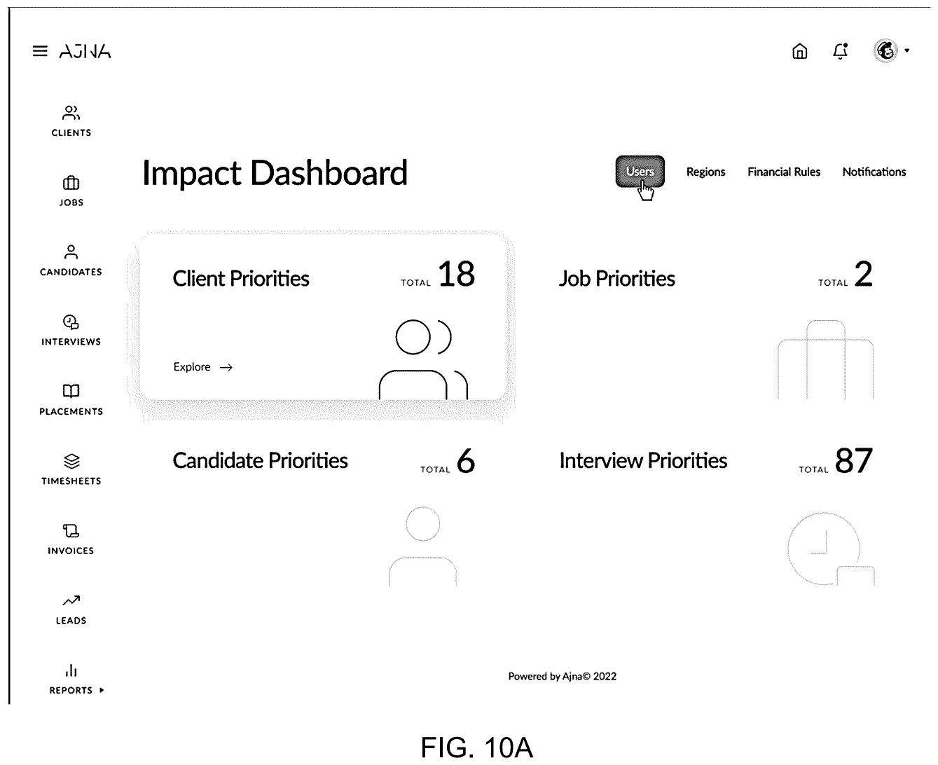

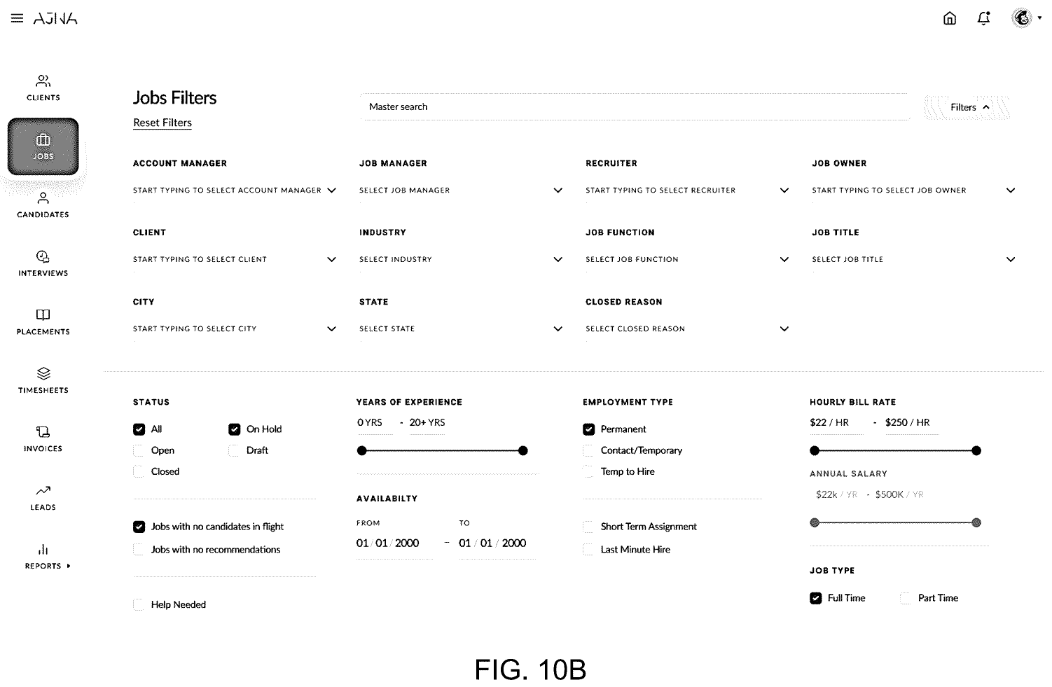

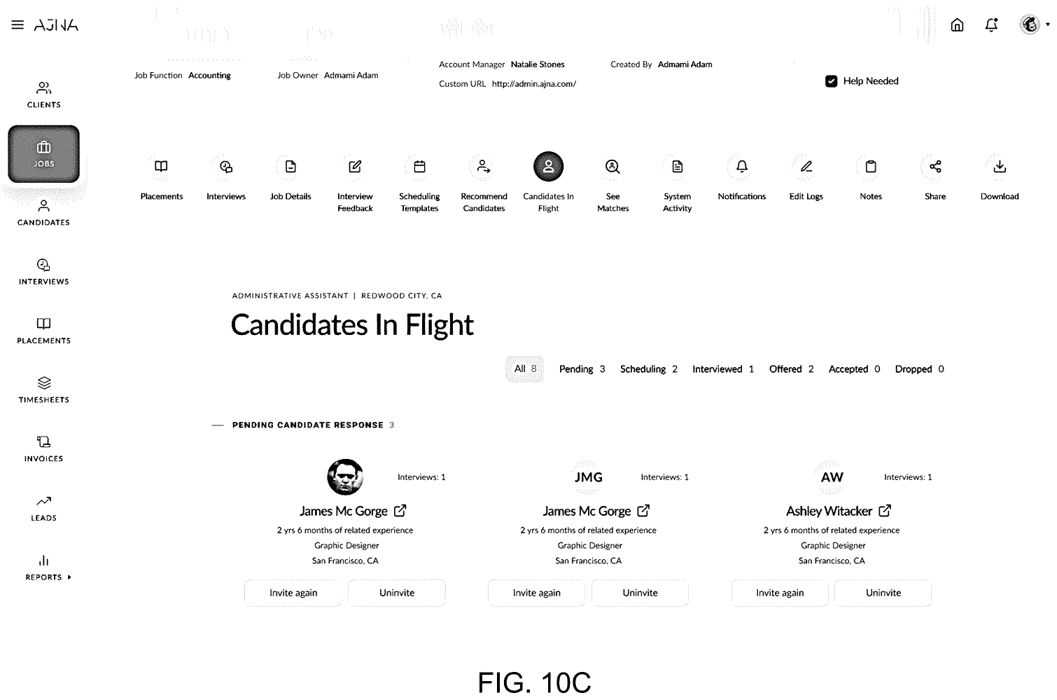

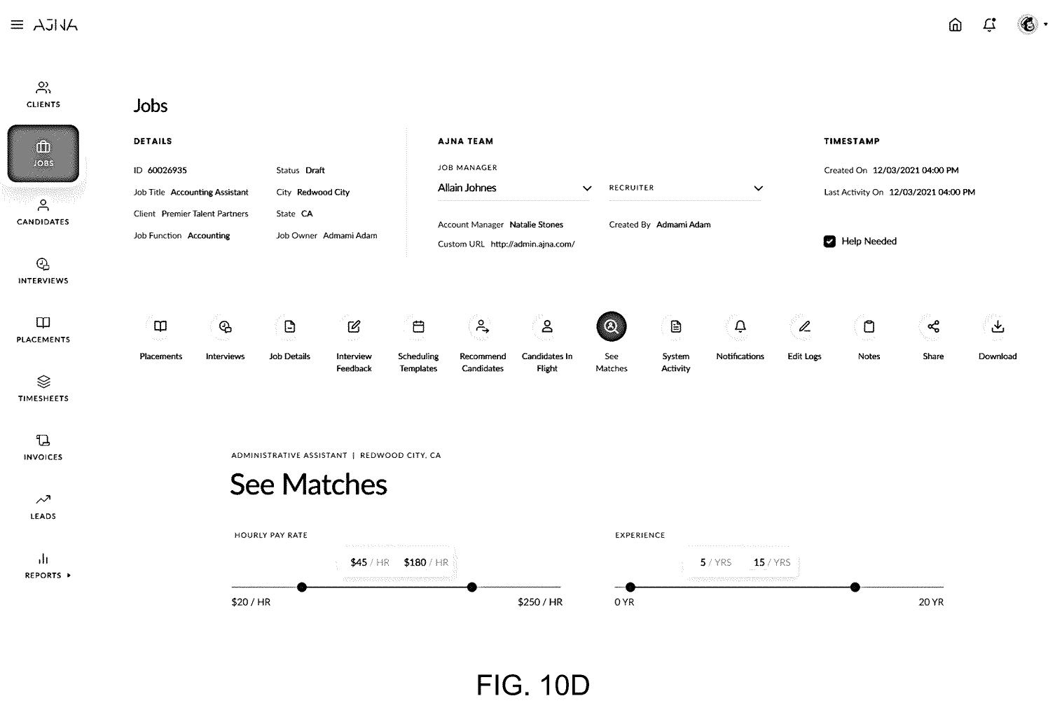

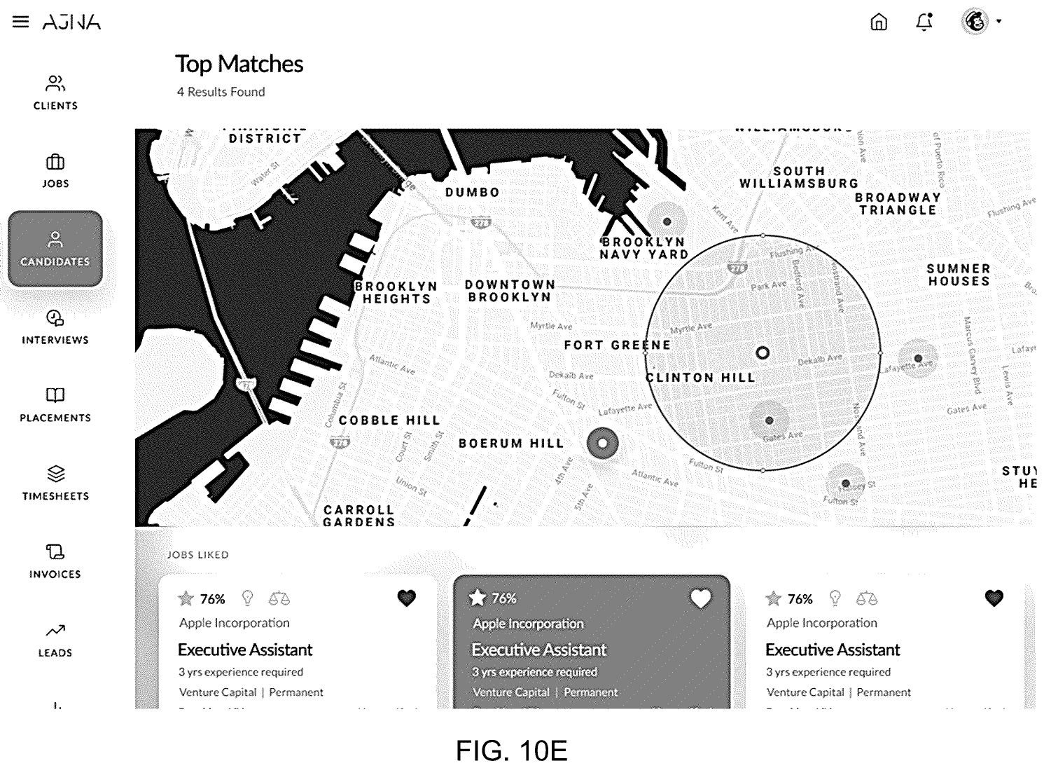

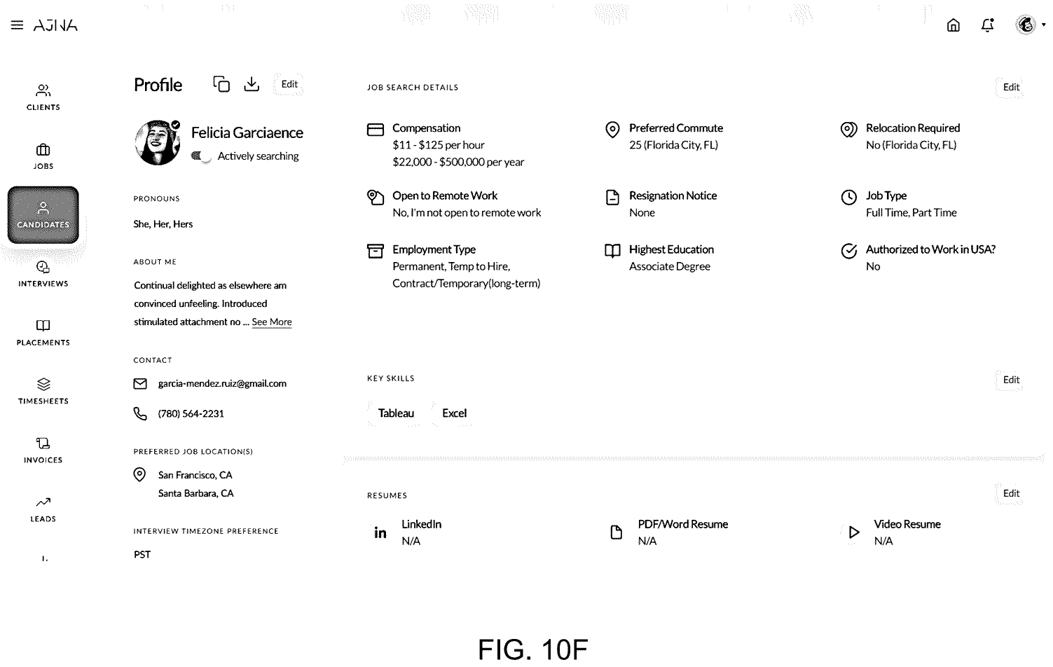

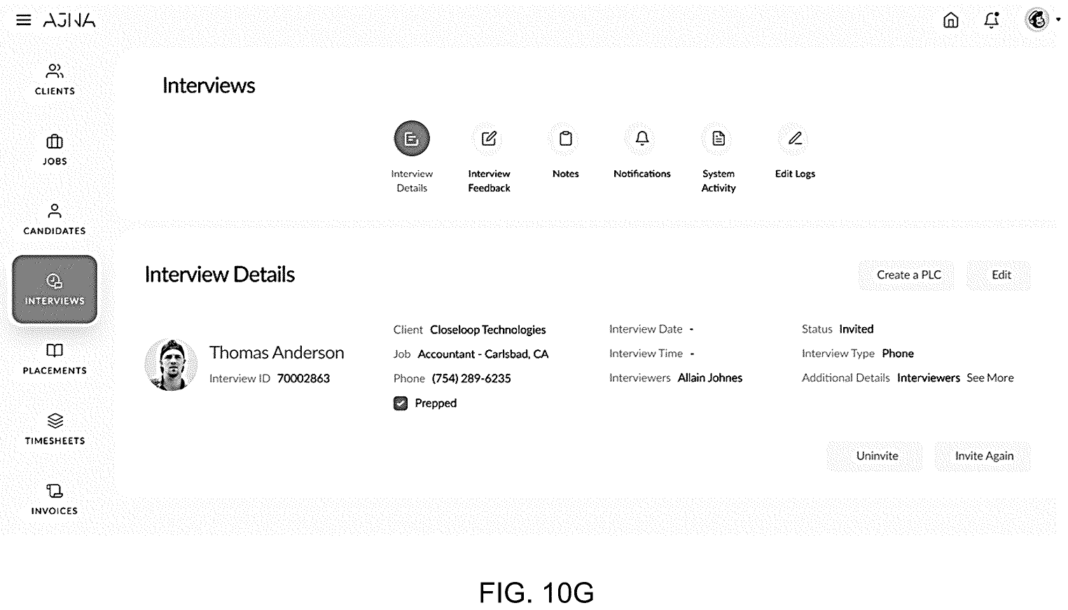

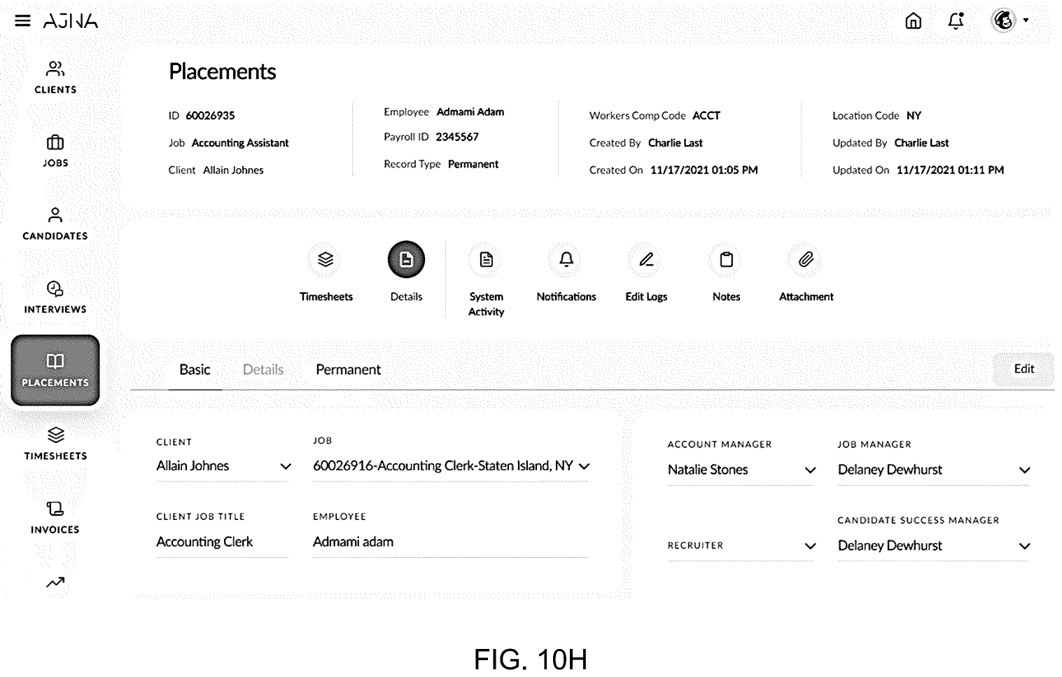

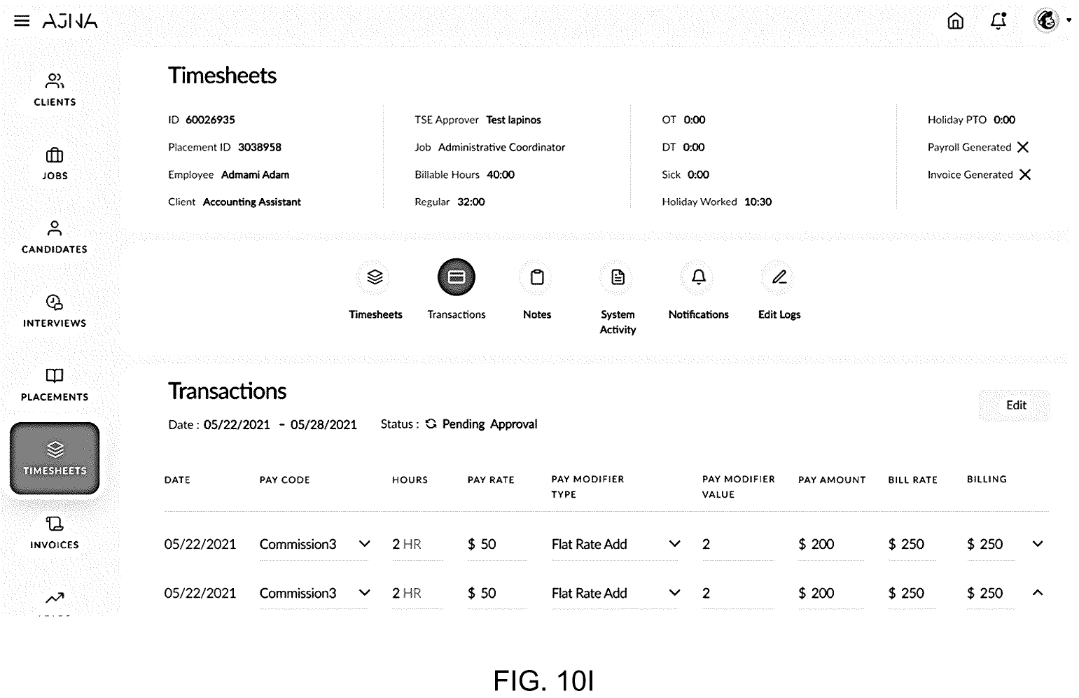

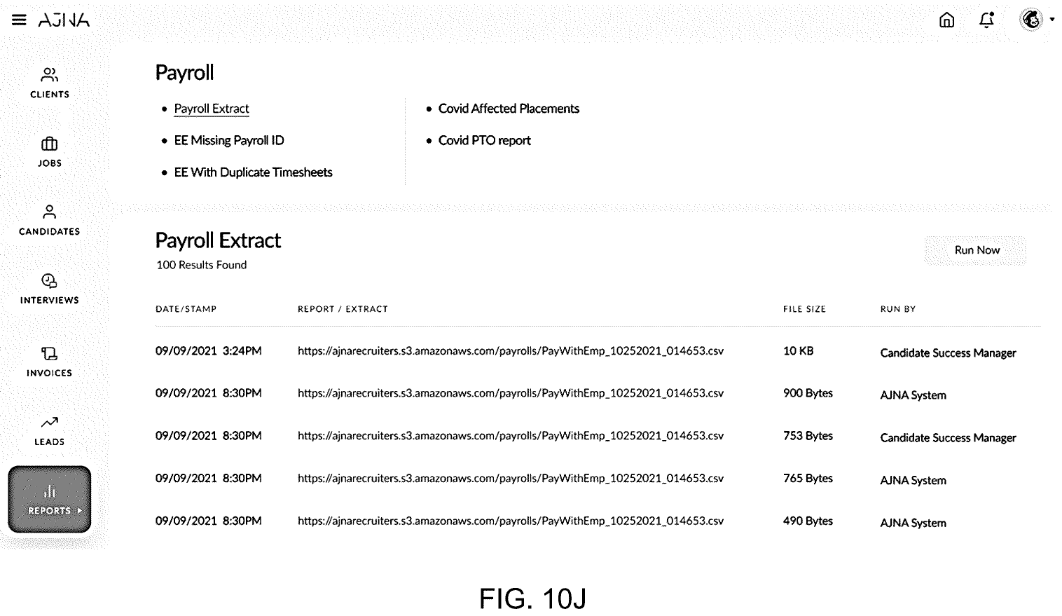

In some embodiments, the GUI for the SaaS platform can be distinctly configured for administrators, candidates (e.g., job seekers), and clients (e.g., employers). FIGS. 10A-10J illustrate example screenshots of an administrator portal for a software-as-a-service (SaaS) platform for skills management and matching. An administrator can use the administrator portal via the impact dashboard (see FIG. 10A), through which the administrator can access job creation and management (see FIG. 10B), matching information (see FIGS. 10C-10E), candidate profiles (see FIG. 10F), upcoming interviews (see FIG. 10G), successful placements (see FIG. 10H), timesheet information (see FIG. 10I), and payroll information (see FIG. 10J).

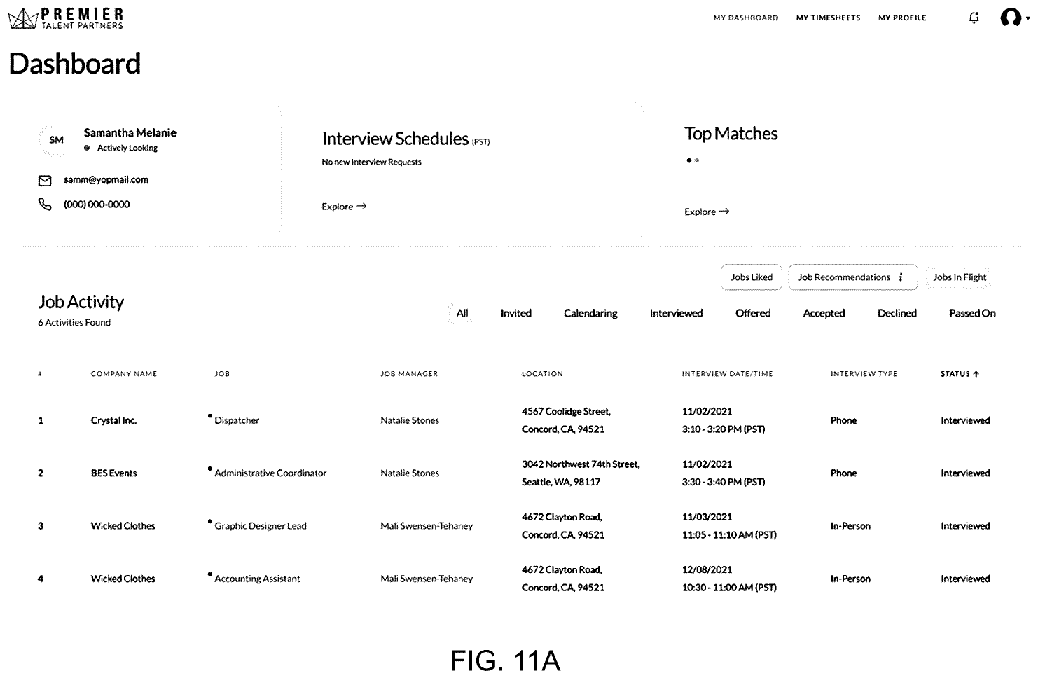

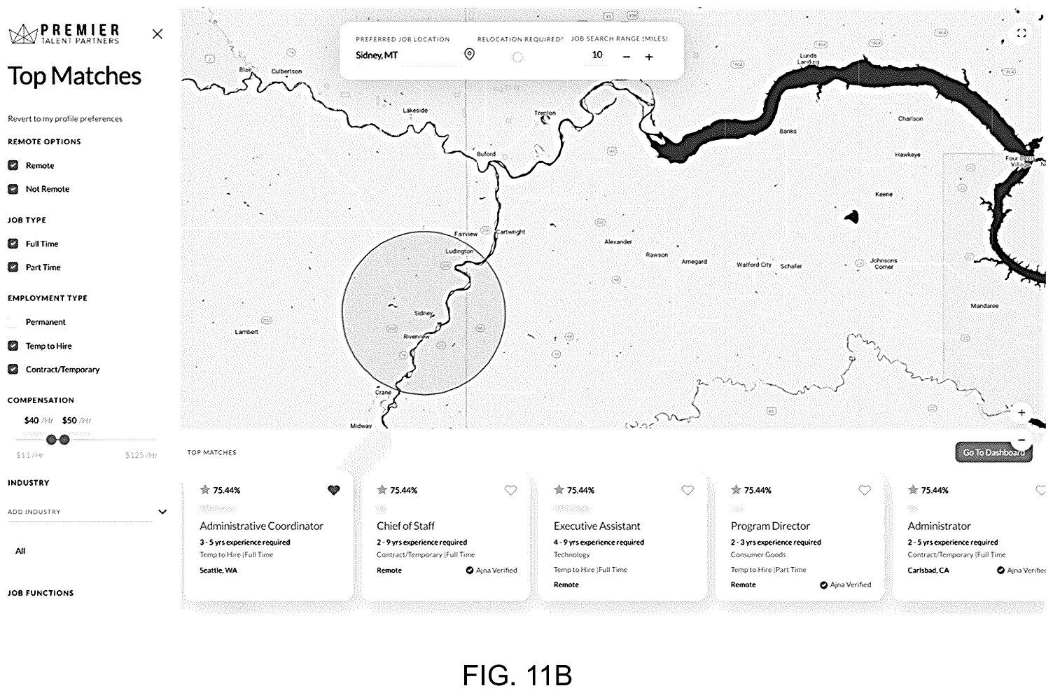

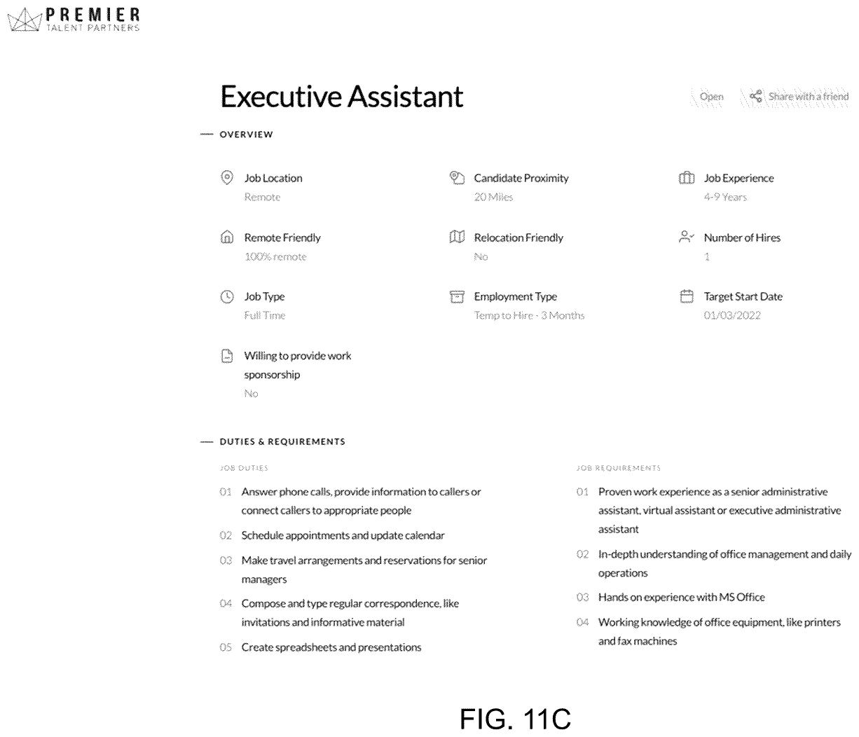

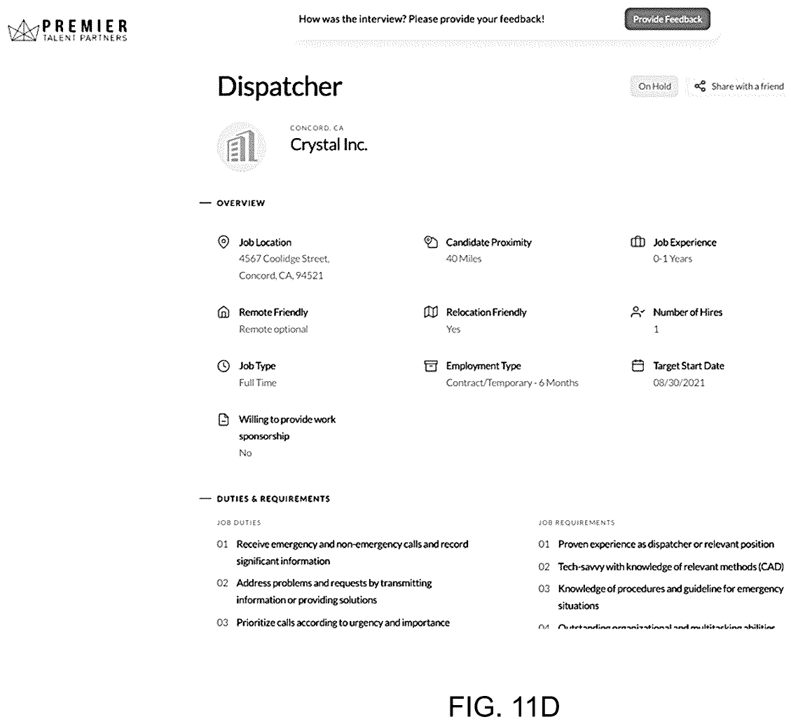

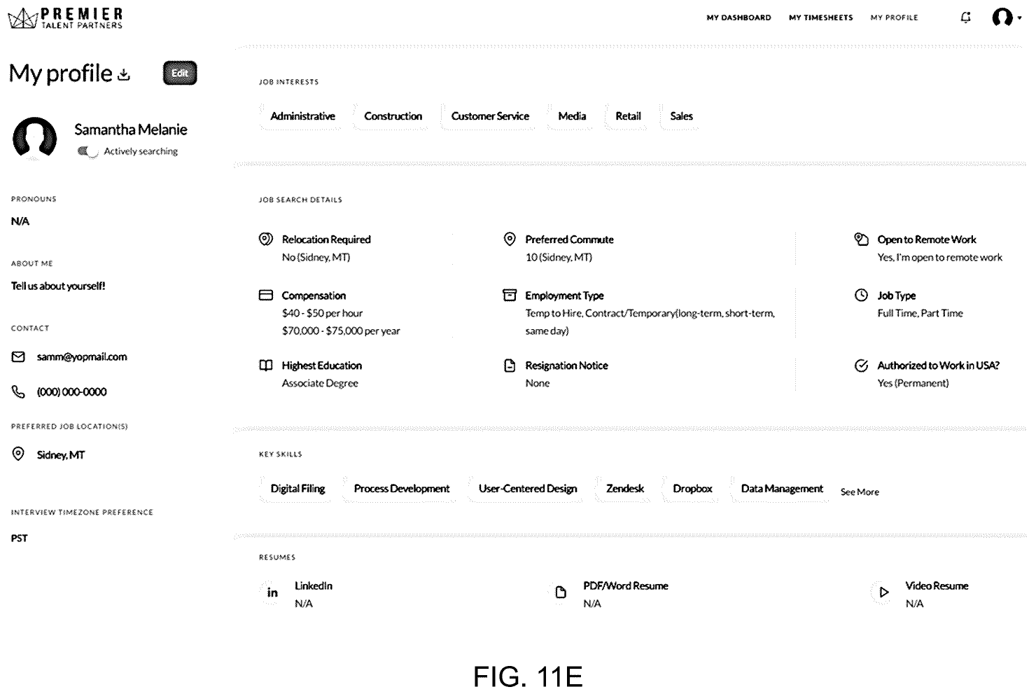

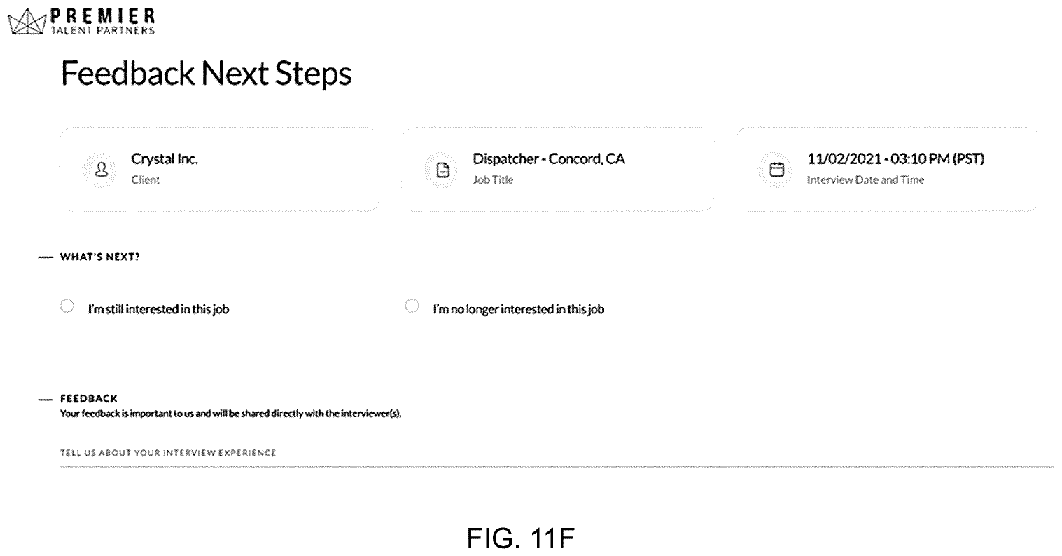

FIGS. 11A-11F illustrate example screenshots of a candidate portal for a SaaS platform for skills management and matching. A candidate using the candidate portal on the SaaS platform typically starts at the dashboard (see FIG. 11A), through which the candidate can see available jobs on a map (see FIG. 11B), details for a particular job (see FIGS. 11C-11D), their profile (FIG. 11E), and leave feedback for an employer (see FIG. 11F).

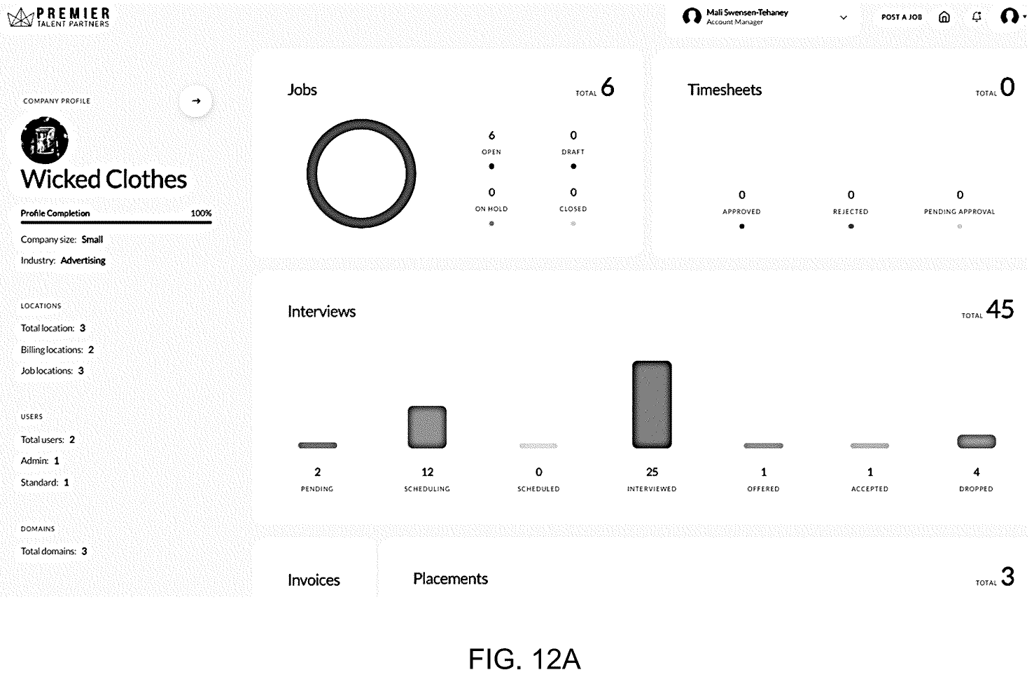

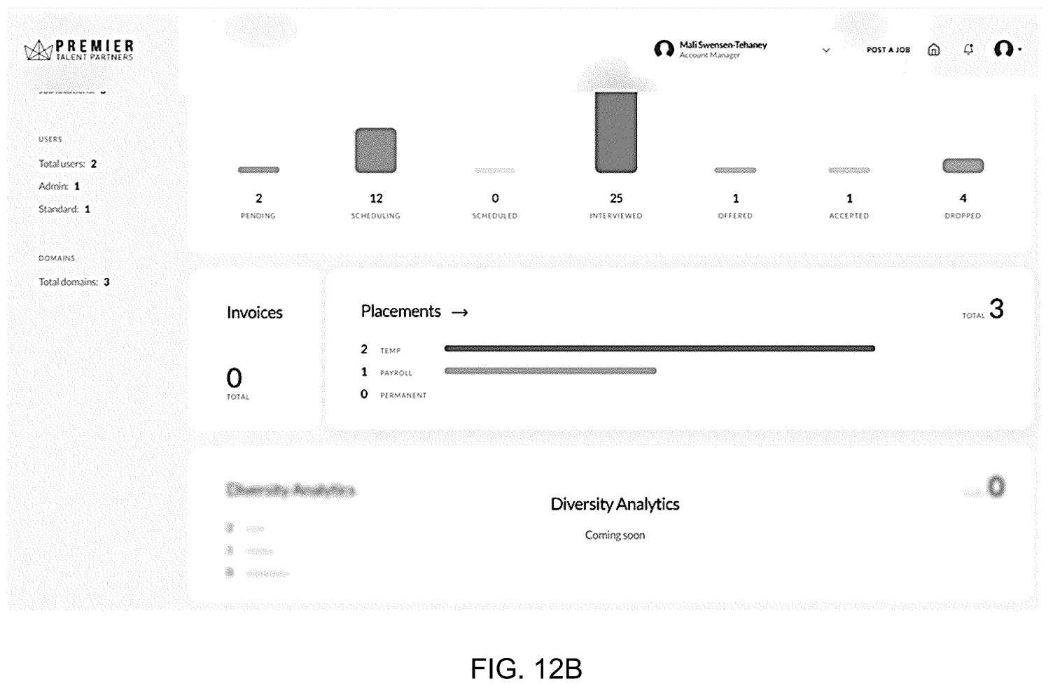

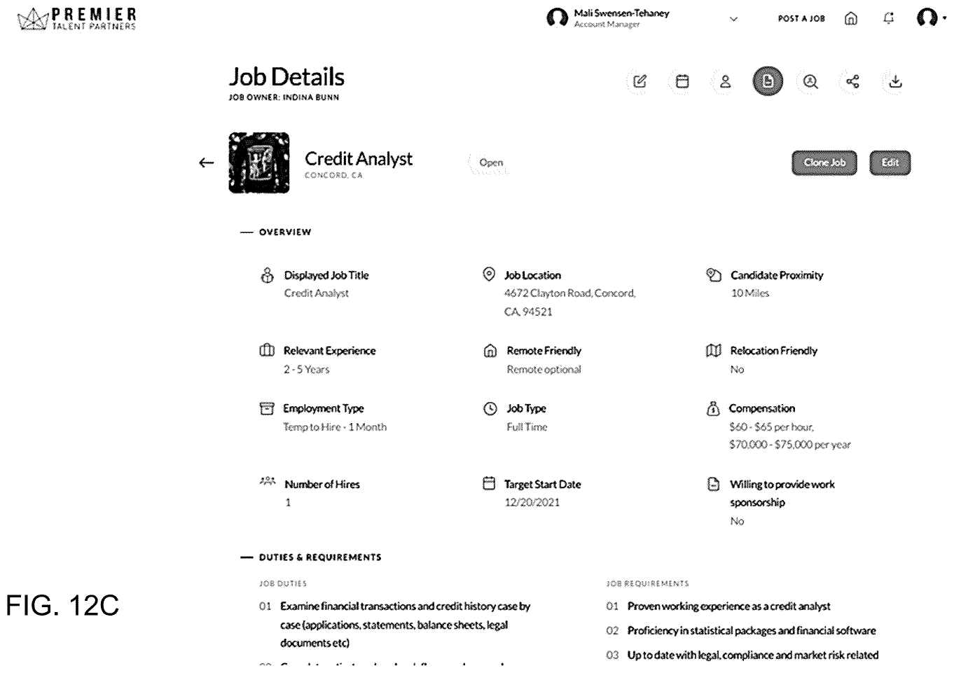

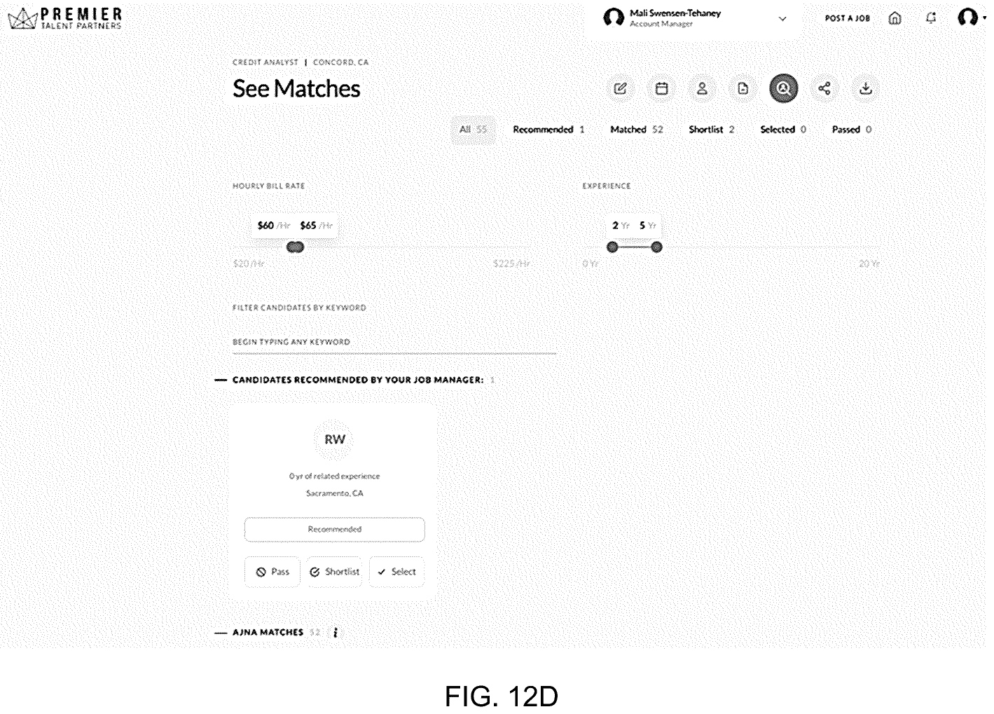

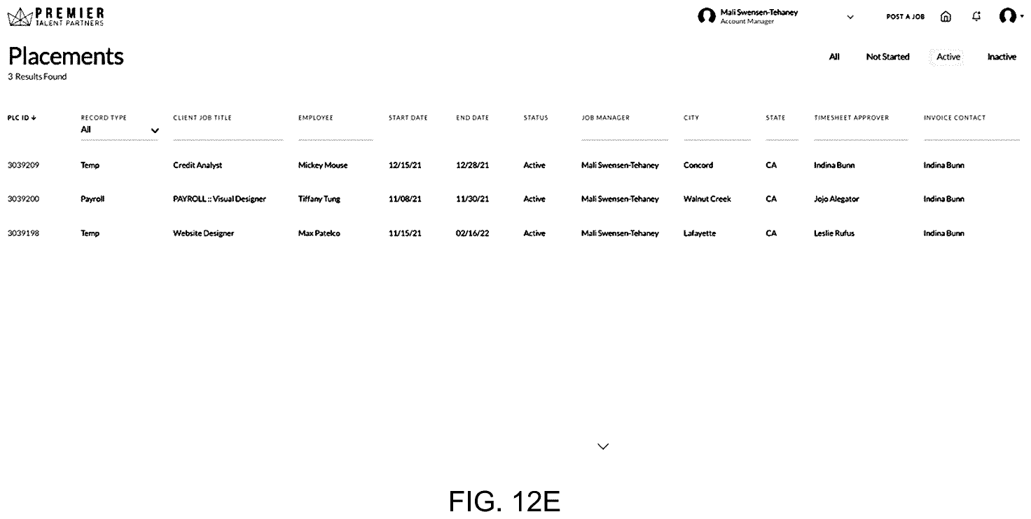

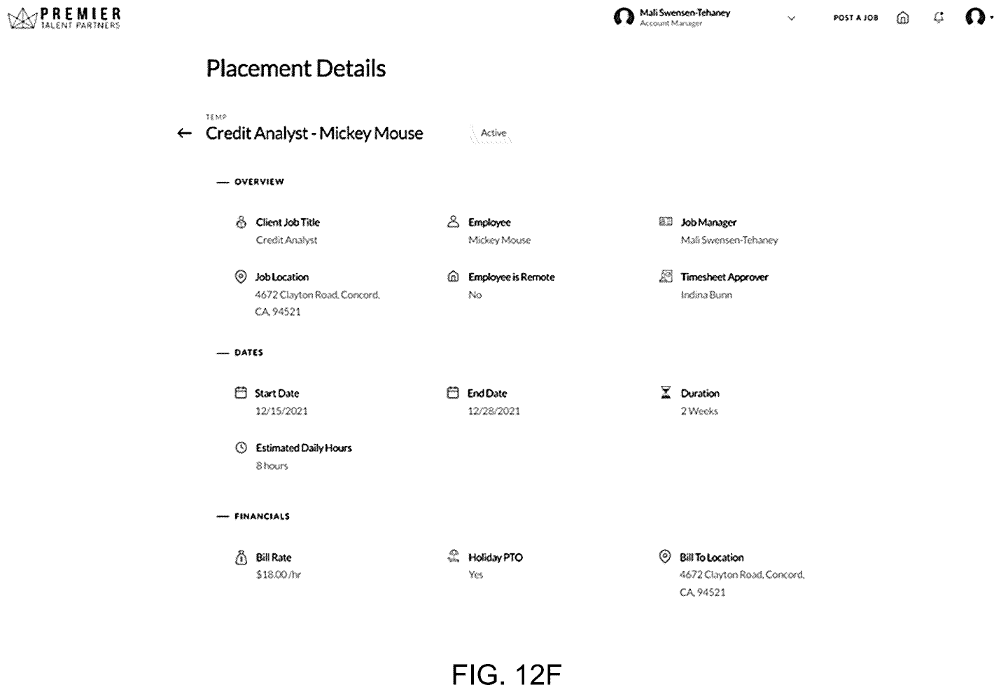

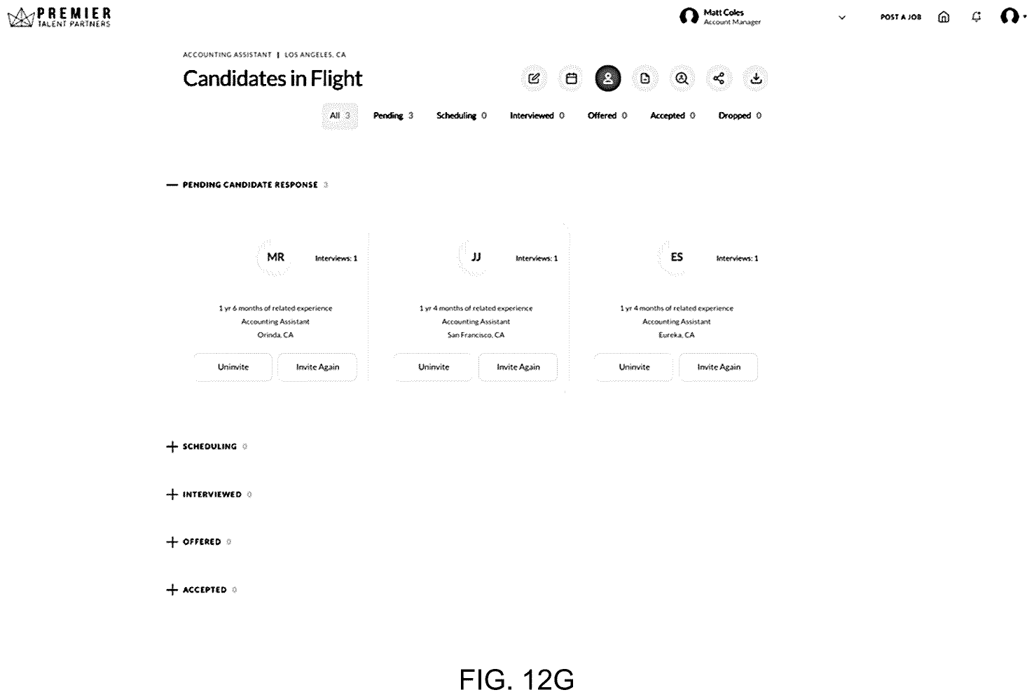

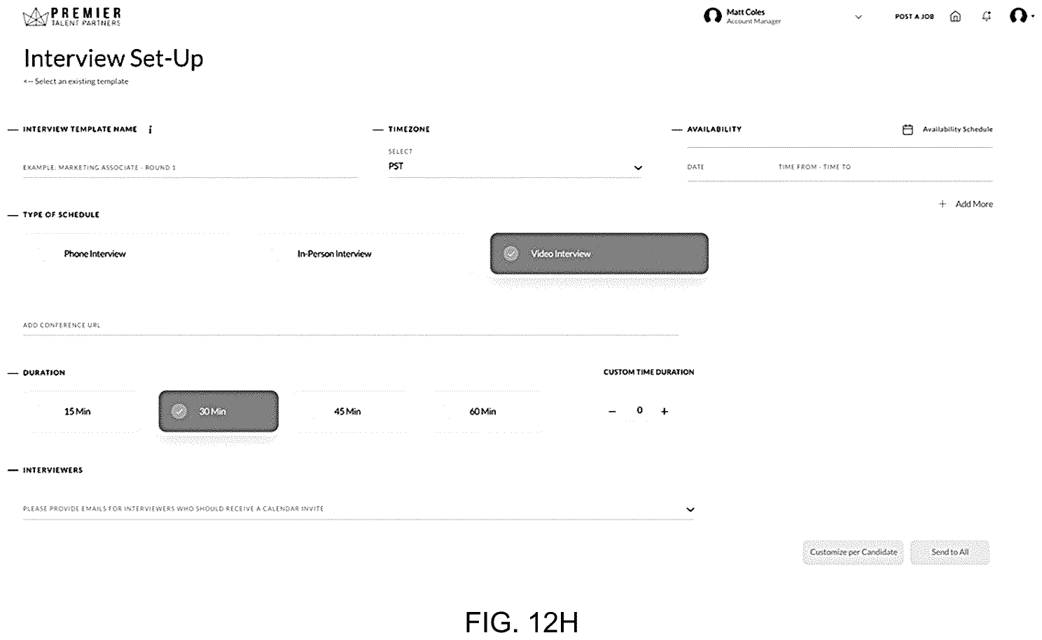

FIGS. 12A-12J illustrate example screenshots of a client portal for a SaaS platform for skills management and matching. A client using the client portal on the SaaS platform typically starts at the dashboard (see FIG. 12A), through which the client can access an overview of job listings and placements (see FIG. 12B), the details of a particular job (see FIG. 12C), any candidate matches (see FIG. 12D), a list of existing placements (see FIG. 12E), details for a particular placement (see FIG. 12F), a list of candidates currently being considered for specific job openings (see FIG. 12G), and setting up an interview for a candidate (see FIG. 12H).

2.2 Architecture for the SaaS Platform

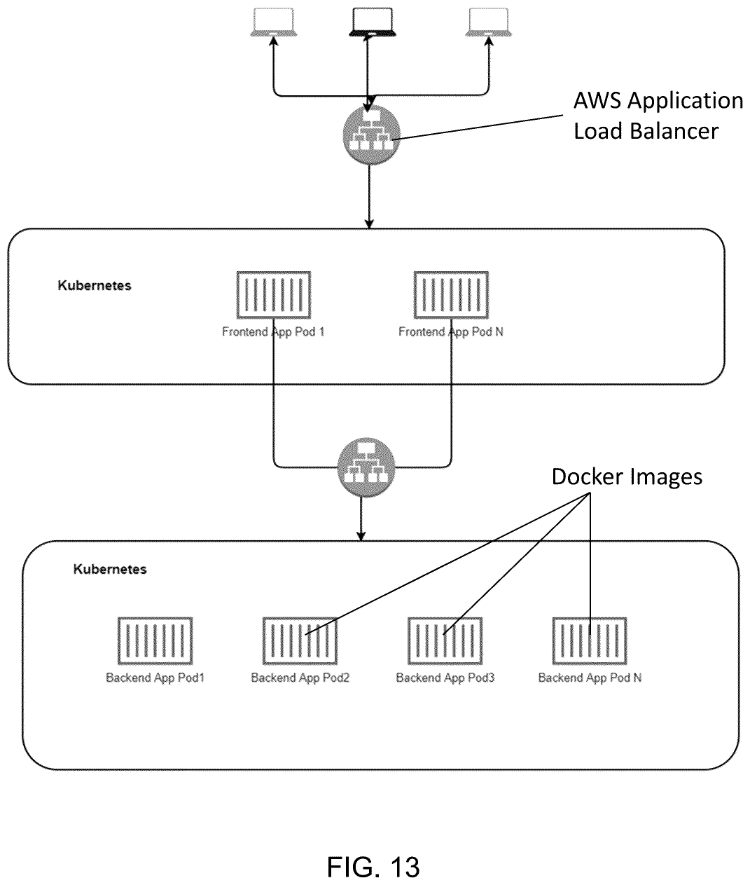

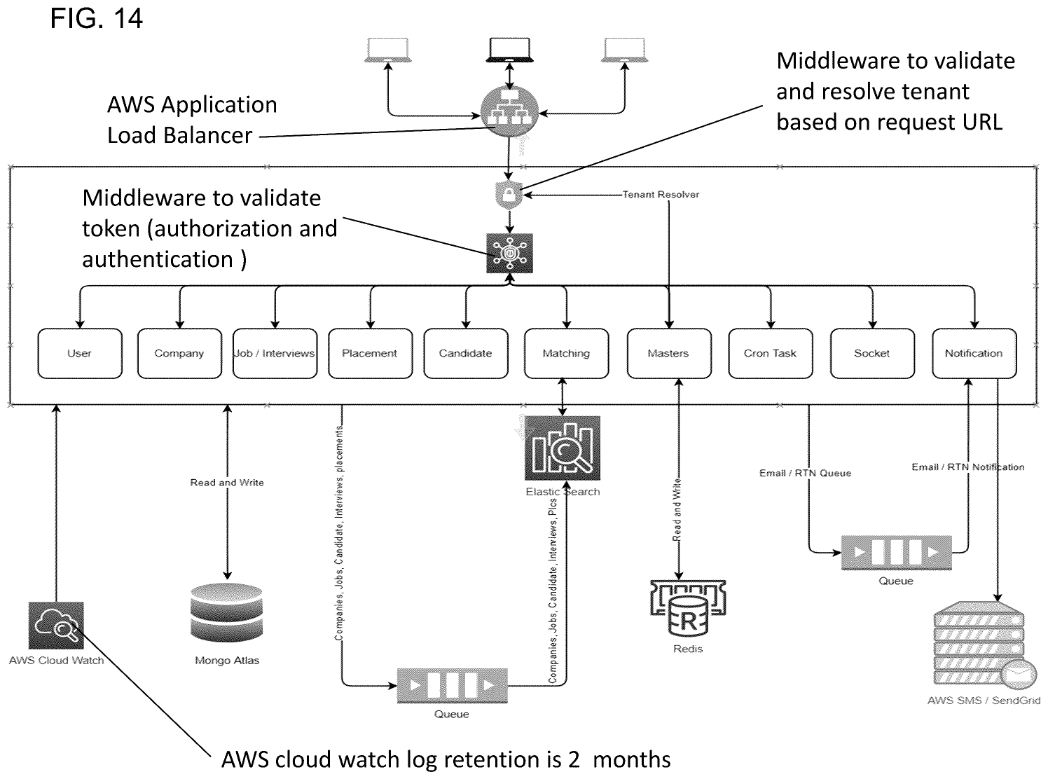

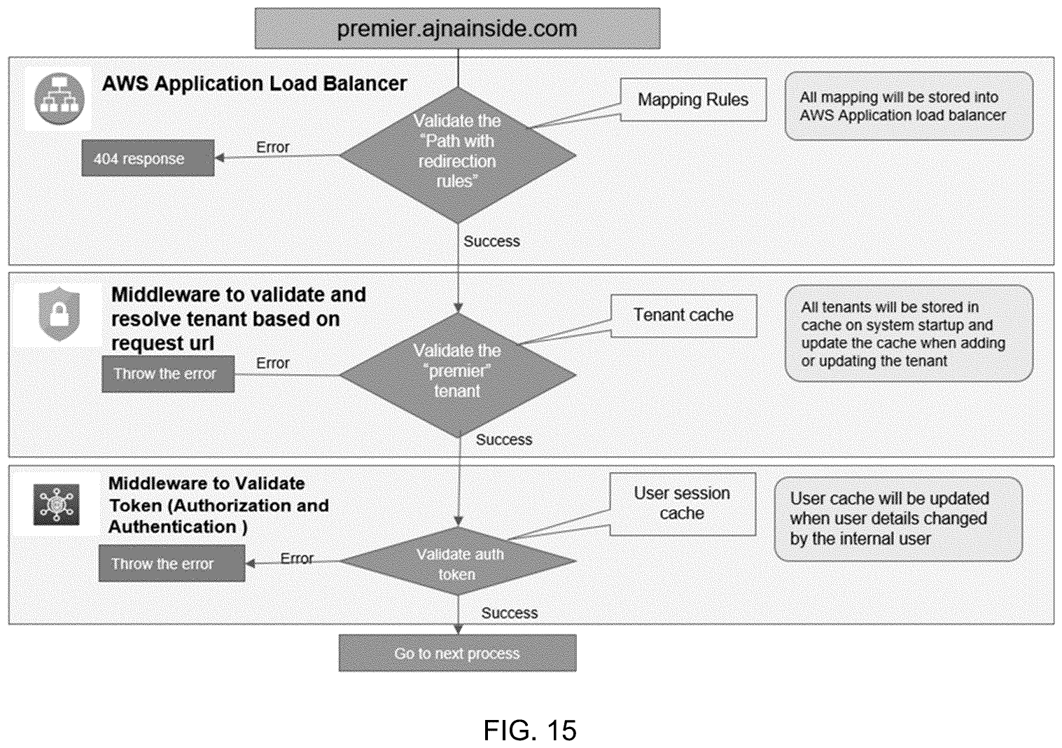

FIGS. 13 and 14 illustrate an example deployment architecture and an example backend system architecture of the SaaS platform, respectively, and FIG. 15 shows operations related to the load balancer and middleware. As in the case of the software platform (in FIGS. 7-9, routing rules are defined into the load balancer and autoscaling policies are implemented (via Kubernetes metrics for the SaaS platform) for both frontend and backend instances.

3 Example Features of the Disclosed Technology

The described embodiments provide methods and systems for skills management and matching, which can be implemented as a software platform (as described in Section 1) or as a software-as-a-service platform (as described in Section 2). Both these embodiments provide, inter alia, the following benefits and advantages:
Translating a job or a resume using a universal language (as described in Section 3.1), which eliminates unconscious bias and exclusion, or mismatching caused by custom job descriptions and resumes. For example, the universal language removes customized “vanity” language of wacky titles and feel-good descriptions to speed up the assessment process.
Eliminating the resume by taking client/candidate preferred skills, experience and qualifications into account to make better quality matches (as described in Section 3.2).
Gating candidate details at the start of the interview stage (as described in Section 3.1), which results in a more qualified talent pool for clients.
Complementing existing HRIS (HR information system) and applicant tracking system (ATS) implementations by mitigating artificial intelligence (AI) bias in those systems and unconscious bias in hiring practices (as described in Section 3.1), thereby uncovering untapped and unseen sources of talent. For example, implementing unbiased features advantageously improves workplace diversity, e.g., with respect to gender, ethnicity, religion, age, and people with disabilities.
Expediting the interview process with just-in-time scheduling, automated communications, increasing transparency for both clients and candidates, and using two-way feedback to get more accepted offers.
Eliminating the liability of storing and tracking candidate information by using secure information transfer and storage protocols.

Examples implementations that achieve some of the advantages and benefits listed above are described in the following sections.

3.1 Unbiased Features

In some embodiments, the software platform (described in Section 1) and the SaaS platform (described in Section 2) can be configured to mitigate AI bias in HRIS and ATS and/or unconscious biases in hiring practices by implementing, for example, the following features:

Algorithmic mapping based on skills. Embodiments of the disclosed technology implement a universal language, which enables globally recognized unbiased descriptions of roles, responsibilities, experience, and qualifications. In an example, using the universal language obviates the necessity of a job description, which may be worded or posted to a location that is inherently biased. The described embodiments implement matching algorithms (as described in Section 3.2) that match candidates (based on their skills) to jobs across the system, and not just to the specific job they are applying for. In another example, a diverse set of hard criteria based on experience and interests are taken into account, thereby casting a wider net for clients to broaden their candidate pools.

In some embodiments, and as shown in FIG. 6E, any job (which corresponds to a job title, job function, and job family) is associated with an enumerated list of, for example, duties and requirements. This enumerated list, which explicitly does not include “vanity” language, is in the universal language and can be used by both candidates and employers to select items that represent a particular aspect of a work opportunity. More generally, the universal language provides one or more libraries of skills, duties, responsibilities, etc. associated with different facets of a work opportunity that are presented in an unbiased format.

In some embodiments, both candidates and employers can iterate through the lists (or libraries) to determine and select items that are relevant for each aspect of their job. These can now be input into the matching operation (described in Section 1.2), which enables the candidate to be matched against jobs that require skills that the candidate possesses, but in an industry or field that the candidate may not have considered previously. Similarly, the matching operation, when used by the employer, can match against candidates that have the skills that the employer needs, even though a particular candidate might not have specifically applied to that posting.

In some embodiments, a machine learning (ML) framework that incorporates natural language processing (NLP) is used to translate a candidate's resume to the universal language. In an example, the ML framework is trained on different job titles, job descriptions, job functions, job skills, experience descriptions, and the like, and can then be used in an inference mode to first extract the relevant details from a candidate's resume, map them to the items in the one or more libraries (or lists) described above, and then matched against available jobs without the matching process being hampered by non-standard job titles that result in clients not finding qualified candidates for open positions.

In some embodiments (and as further described in Section 3.2), the candidates are assigned a matching score based on multiple factors, which include experience, job function, job duties and requirements, job type, compensation, employment type, location and proximity, work sponsorship, job title, and the like. In an example, the matching algorithm looks at relevant experience and not all experience within the job function and job title, and does not discriminate based on past experience, thereby opening the door for a diverse array of candidates with different backgrounds. In another example, the matching algorithm takes into account past experience and desired positions, thereby allowing for entry into/transition into desired field of work. In yet another example, the client is required to provide their salary range up front so they cannot apply bias to those candidates who are either expecting a much higher salary or willing to settle for significantly less.

Redacted candidate profiles. In some embodiments, one or more aspects of the candidate profile are kept hidden during one or more stages of the matching process. In an example, the candidate's photo is hidden until an in-person or video interview has been completed. In another example, only a candidate's preferred name, rather than their legal name, is captured and propagated throughout the platform. In yet another example, the first and/or last name of the candidate are hidden until an interview is scheduled. In yet another example, a candidate's pronouns are only display (or made available) after an interview is scheduled. In yet another example, profiles on the platform can be configured to not capture the age of the candidate. In yet another example, only the highest degree of education, rather than university and/or school names and graduation years, are shown. In yet another example, only the general experience and industry of a candidate, instead of specific company information related to prior employment, are shown to the client to eliminate systemic bias. In yet another example, only the general industry and size of a client, instead of the name and location of the client, are shown to the candidate. In yet another example, only where the candidate prefers to work (and not where the candidate resides) is shown to the client.

In some embodiments, a conventional “resume” section is hidden during the selection process, which gates access to a candidate's resume, LinkedIn® profile, and/or video resume. In an example, this information is made visible after an interview is scheduled (or after another subsequent stage of the skill management and matching process). Instead, a holistic standardized profile of the candidate is provided to clients, which provides details related to job functions, titles, duties, and skills. This approach advantageously mitigates bias that may result from how a particular candidate articulates their experience.

Interview scheduling process. In some embodiments, one or more identifying features of the candidate are kept hidden from clients until a specific phase of the process. For example, a client with an implicit bias may discount a candidate if they do not respond, but this outcome is mitigated using the automatic follow-up features of the described embodiments.

3.2 Matching Algorithm Features

In some embodiments, one or more criteria are used to determine a matching from a job to a candidate (e.g., a client employment opportunity that is available for which one or more candidates is eligible) and a matching from a candidate to a job (e.g., a candidate who is looking for an employment opportunity and is considering one or more jobs that are available with one or more clients/employers). The criteria enumerated below are determined, in some cases, based on the Experience of the candidate, and include:
Job Function; e.g., Desired Job Function (for job to candidate matching) or the Job Function based on Experience (for candidate to job matching).
Job Title; e.g., Title from Experience, which can be adjusted based on the Job Family. For example, a candidate with experience as a Legal Assistant would likely have skills and experience that would transfer over to a job for an Administrative Assistant, which is a case of a different Job Title but within the same Job Family. The described embodiments include scaling factors that can be configured to ascertain the overlap between different Job Titles within the same Job Family (and in some cases, across a different Job Family).
Job Duties; e.g., Duties from Experience
Job Requirements; e.g., Requirements from Experience
Additional Job Functions—Specific Questions; e.g., area of expertise questions for a Job Function that the candidate has the most experience in
Additional Key Skills
Experience Level; e.g., total experience in the same Job Function as the job
Recency; e.g., as it relates to Job Title, Job Function, and Job Family
Compensation; e.g., desired compensation
Employment Type (Contract, Contract to Hire (CTH), Permanent)
Job Type (Full Time, Part Time)
Preferred Proximity; e.g., preferred job location
Remote Friendly; e.g., open to remote work
Relocation Friendly; e.g., open to relocation, which is only applicable to candidate to job matching
Work Sponsorship

In some embodiments, the matching from the candidate to the job is a weighted sum of (1) Job Function, (2) Experience Level, (3) Compensation, Employment Type (Contract, Contract to Hire, Permanent), (4) Job Type (Part Time, Full Time), (5) Preferred Proximity, and (6) Remote Friendly, but not the other criteria. To determine a matching, each of these criteria is scored (e.g., S1, S2, . . . , S6) and assigned weights (e.g., w1, w2, . . . , w6), and the matching is determined as M=w1×S1+w2×S2+w6×S6. In an example, the maximum score for each of the criteria is 100 and the weights are assigned such that the sum of the weights is equal to 100.

The score for each criterion is determined uniquely for that criterion, and depends on whether the criterion is being evaluated for job to candidate matching or candidate to job matching. Similarly, the weight assigned to the criteria may be different for job to candidate matching as compared to candidate to job matching.

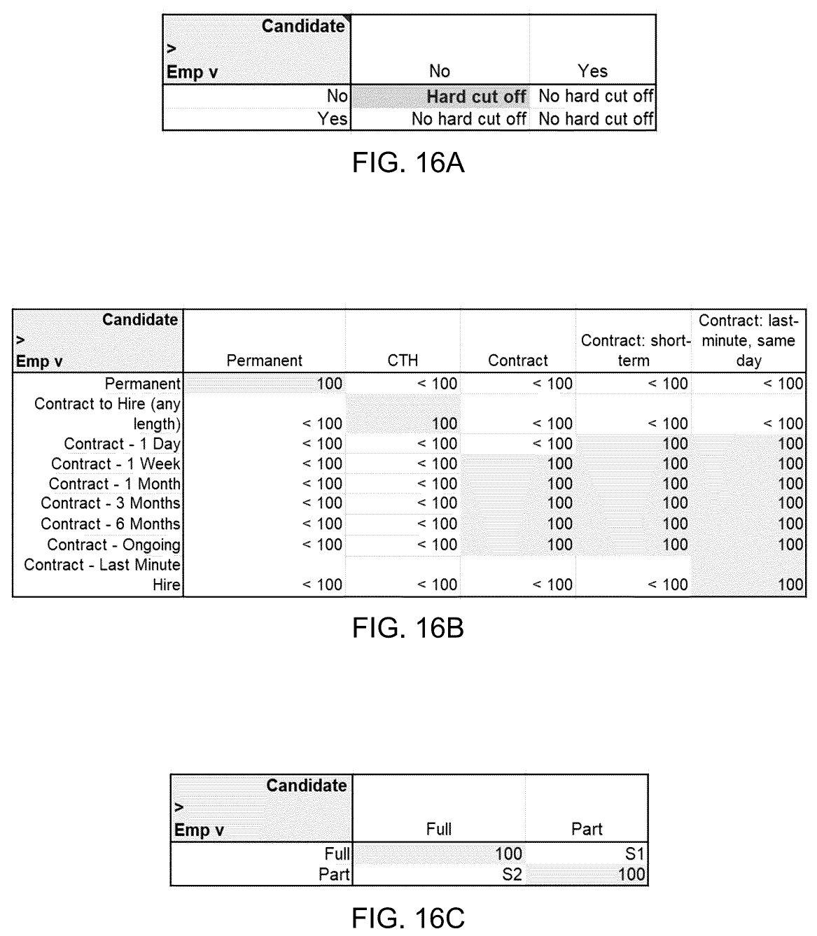

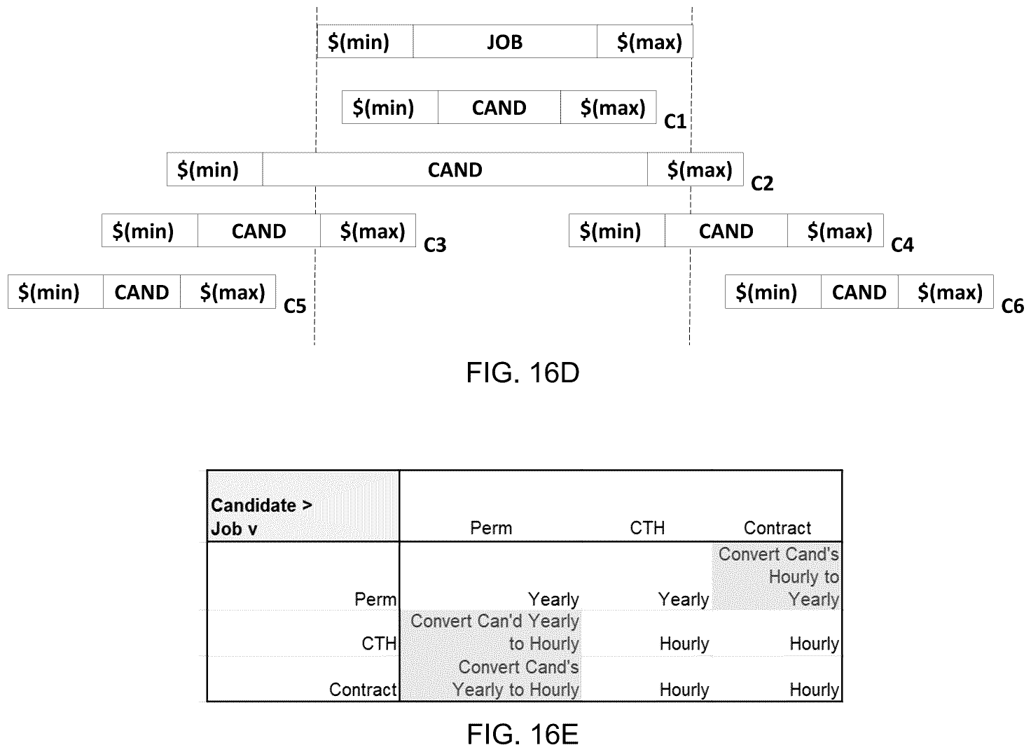

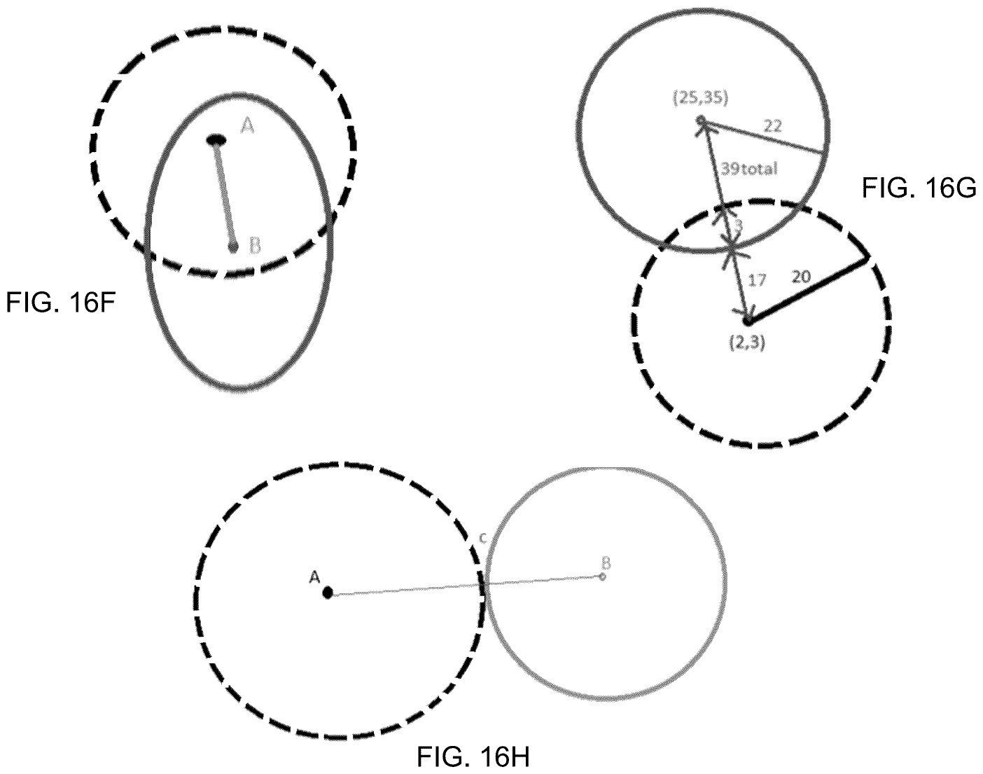

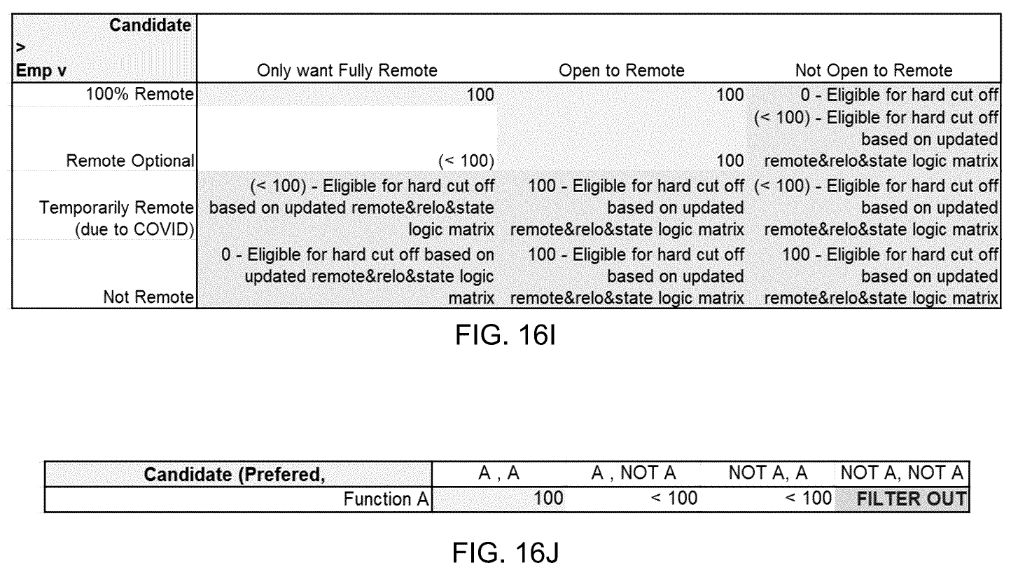

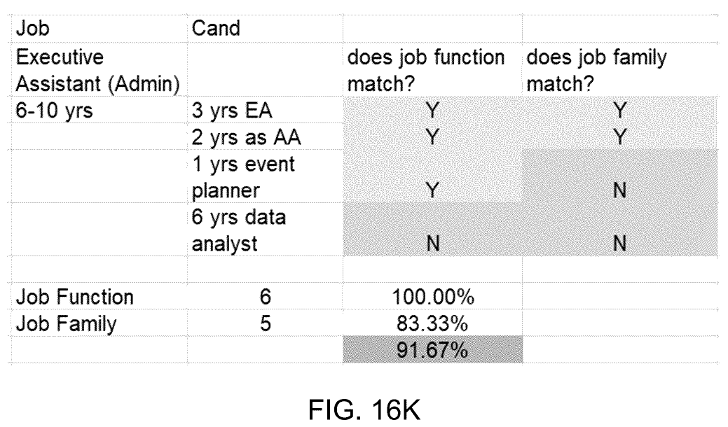

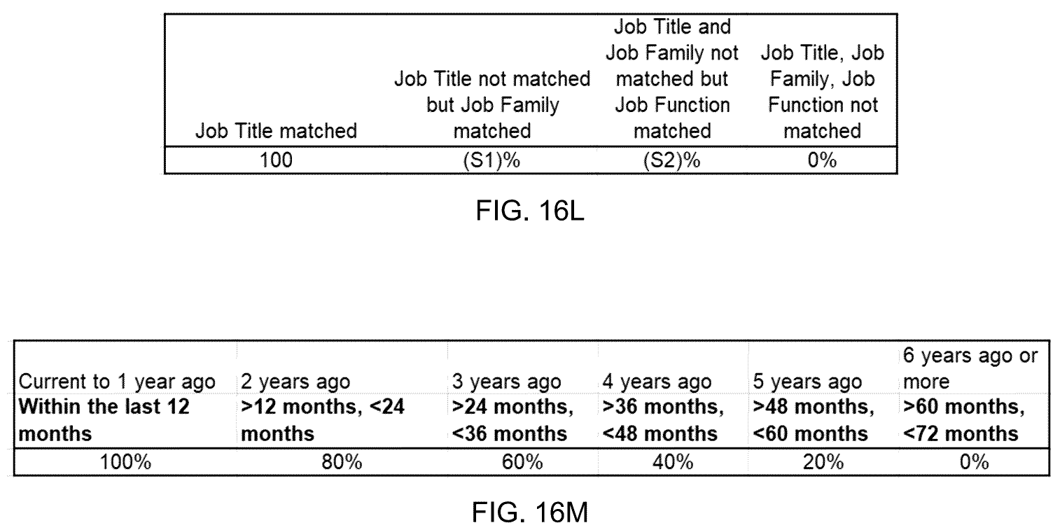

Work Sponsorship. In an example, the score for Work Sponsorship, for job to candidate matching, is determined as shown in FIG. 16A. Herein, only when the candidate requires work sponsorship and that cannot be provided by the employer, is there a hard cutoff, and the candidate cannot be considered for that particular position.

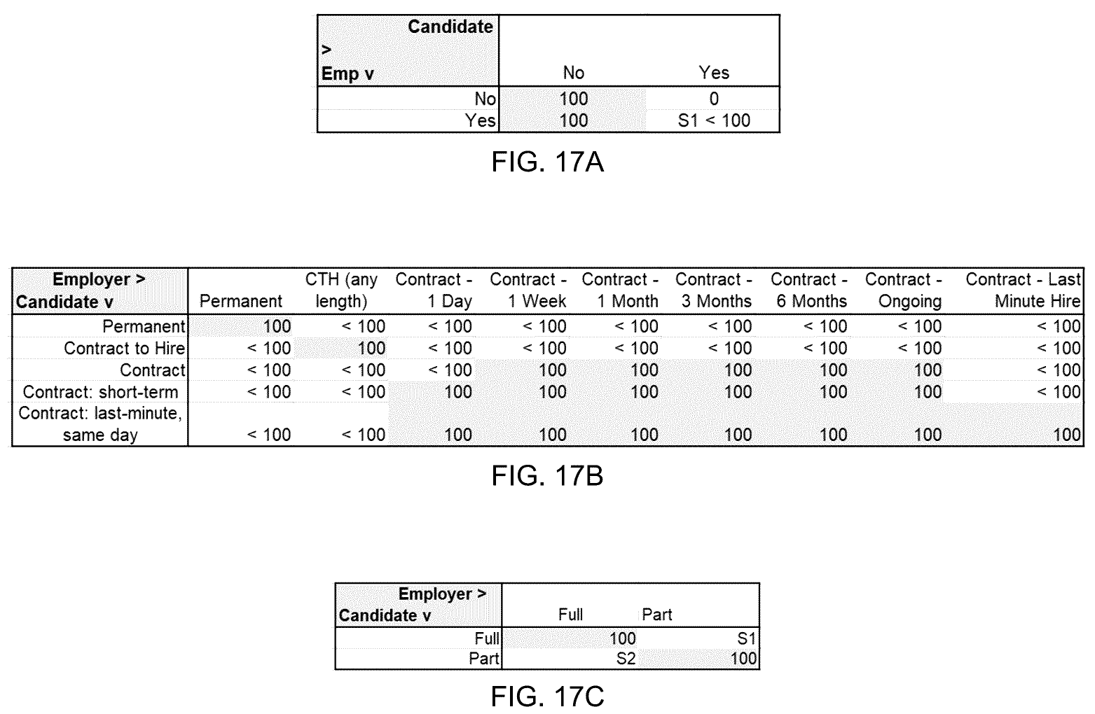

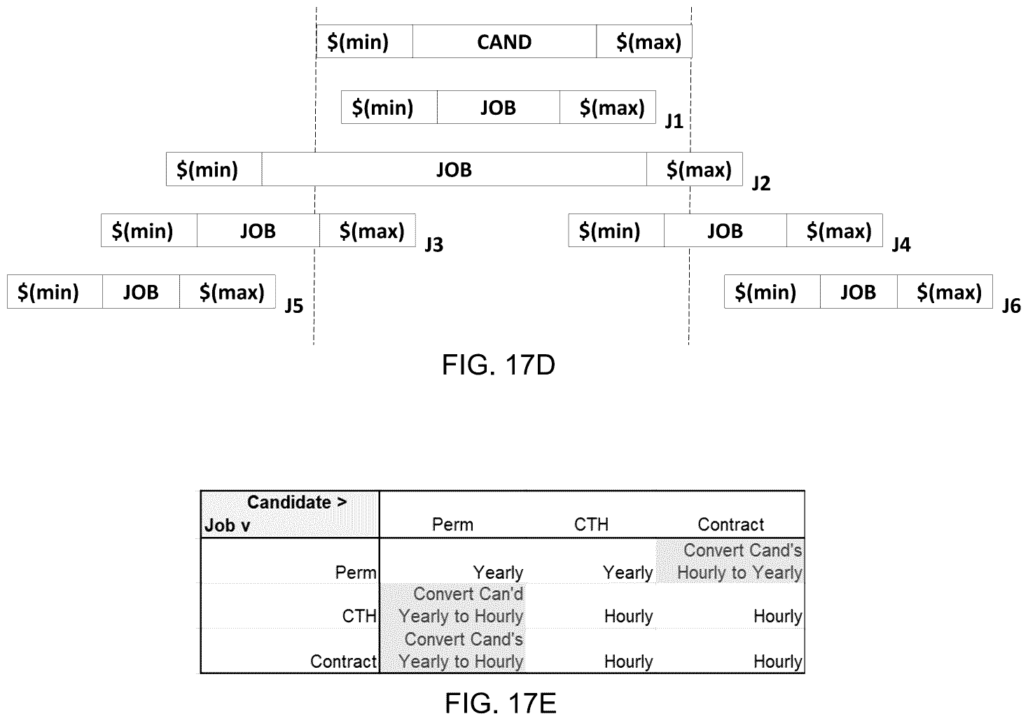

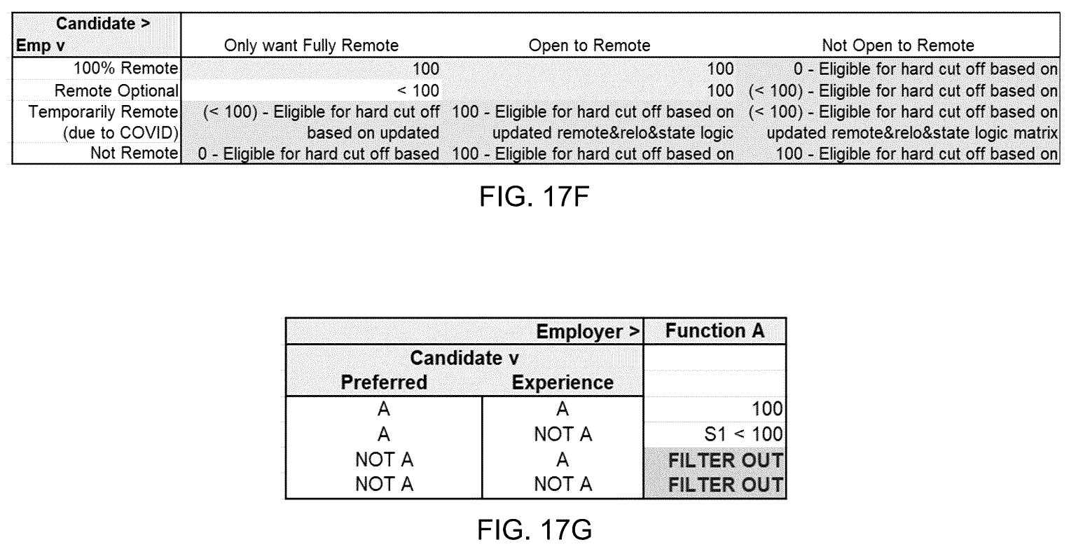

In another example, for candidate to job matching, the score for Work Sponsorship is determined as shown in FIG. 17A. As shown therein, a maximum value is assigned to the Work Sponsorship when the candidate does not need to be sponsored, a value less than the maximum value is assigned when the candidate need work sponsorship and the employer is able to sponsor the candidate, and a zero value is assigned when the candidate need work sponsorship and the employer is unable to sponsor the candidate.

Employment Type. In an example, the score for Employment Type, for job to candidate matching, is determined as shown in FIG. 16B. Herein, a maximum value for the score is achieved when the employment type of the candidate matches that of the employer (e.g., both Permanent, both Contract to Hire, the candidate applying on a Contract basis and the employer offering a Contract position greater than one week, etc.). Other combinations of the employment type result in another score that is less than the maximum value.

The values assigned to the score for Employment Type for candidate to job matching is shown in FIG. 17B, and as discussed earlier, is different than the values assigned in job to candidate matching.

Job Type. In an example, the score for Job Type is determined, for job to candidate matching, as shown in FIG. 16C, and for candidate to job matching in FIG. 17C. Herein, S1<S2<100. That is, if the job requirement is Full Time or Part Time, and the candidate preference matches this, i.e., Full Time or Part Time, respectively, then the score for the Job Type will be 100. If the job requirement is Full Time and the candidate preference is Part Time, then the score will be S1, whereas if the job requirement is Part Time and the candidate preference is Full Time, then the score will be S2. For example, S1=10 and S2=20.

In an example, the Job Type criterion may be allocated a weight of 10 for job to candidate matching (as shown in FIG. 16C), but a weight of 20 for candidate to job matching (as shown in FIG. 17C), which reflects the different importance of this particular criterion to the client and the candidate, respectively. In some embodiments, the weights for each of the criteria may be equal for one of the matchings, but different for the other.

Compensation. In an example, the score for Compensation is determined, for job to candidate matching, as shown in FIGS. 16D and 16E. The score for Compensation depends on the maximum wage and minimum wage (e.g., as advertised by the employer) and the maximum and minimum desired compensation of the candidate. As shown in FIG. 16D, a maximum value is assigned to the Compensation score when (a) both the maximum desired compensation is less than the maximum wage and the minimum desired compensation is greater than the minimum wage, or (b) both the maximum desired compensation is greater than the maximum wage and the minimum desired compensation is less than the minimum wage.

In these examples, “greater than” is used for simplicity, but “greater than or equal to” is also a viable option, unless other stated.

Other values less than the maximum value are assigned to the compensation score in the other scenarios shown in FIG. 16D, which include the maximum desired compensation being greater than the minimum (or alternatively, the maximum) wage and the minimum desired compensation being less than the minimum (or alternatively, the maximum) wage. In the case that the entire range of desired compensation is less than the minimum wage, the value assigned to the compensation score decreases at a first rate, reaching zero when the maximum desired compensation is a factor of X less than the minimum wage. Similarly, in the case that the entire range of desired compensation is greater than the maximum wage, the value assigned to the compensation score decreases at a second rate, reaching zero when the minimum desired compensation is a factor of Y more than the maximum wage. In an example, X and Y are real numbers between 1.0 and 2.0. In another example, the second rate is greater than the first rate.

FIG. 17D illustrates the determination of the Compensation score for candidate to job matching, and is similar to the methodology described above in the context of FIG. 16D. In the examples shown in FIGS. 16D and 17D, the maximum value of the Compensation score may be 100 (e.g., C1=C2=100 in FIG. 16D, and J1=J2=100 in FIG. 17D), and each of C3-C5 and J3-J5 (the scores for the other scenarios in FIGS. 16D and 17D, respectively) is less than 100.

FIGS. 16E and 17E show that for certain employment types, an hourly wage may need to be converted to a yearly wage, or vice versa, to compute the Compensation score.

Proximity. In an example, the score for Proximity is determined, for job to candidate matching, as shown in FIGS. 16F-16H. The score for Proximity depends on the location of the candidate, a proximity of the candidate (shown as a solid circle), a location of the job, and a proximity of the job (shown as a dashed circle). In an example, the proximity of the candidate corresponds to a commute the candidate is willing to make (either on a frequent basis for an in-person job, or infrequently for a job that is partially remote). In another example, the proximity of the job corresponds to transportation services provided by the employer for its employees (e.g., shuttle services that transport employees from a public transit center to the job campus).

For the case shown in FIG. 16F, when the distance between the location of the candidate and the location of the job is within an overlapping region of both the proximity of the job and the proximity of the candidate, a maximum value is assigned to the Proximity score. A value less than the maximum value is assigned in the case of FIG. 16G, and the value is based on the amount of overlap between the proximity of the job and the proximity of the candidate. The Proximity score is assigned a zero value in the case of FIG. 16H when the proximity of the job and the proximity of the candidate do not overlap.

Remote and/or Relocation. In an example, the score for Remote and/or Relocation is determined, for job to candidate matching, as shown in FIG. 16I, and for candidate to job matching as shown in FIG. 17F. As shown in FIG. 16I, a maximum value is assigned to the score for Remote and/or Relocation when the candidate only wants to work remotely or is open to working remotely, and the work opportunity is one that can entirely be performed remotely (denoted “100% Remote” in FIG. 16I). If the job has a remote work option, then a less than maximum score is assigned if the candidate only wants to work remotely, whereas a score of zero is assigned if (a) the job is entirely remote, and the candidate only wants an in-person job of (b) the job is an in-person work opportunity, and the candidate is only interested in remote work.

As shown in FIG. 16I, a value less than the maximum score is assigned in other scenarios, and the value is determined based on at least one of the employer offering relocation and the candidate being willing to relocate, the job location and the candidate location (without relocation) being in the same state or adjacent states, and/or the job being able to be performed remotely and the candidate's preference for remote work. When the candidate location and the job location are relatively close (e.g., an hour's commute), then the calculations used in determining the Proximity score can be used to determine the Remote and/or Relocation score.

Function. In an example, the score for Function (the department the job is part of, e.g., human resources, etc.) is determined, for job to candidate matching, as shown in FIG. 16J. If the job is offered within a specific Function, a maximum value is assigned to the Function score if the candidate is within that Function and prefers to remain in that Function. If the candidate is currently not in that Function but would be amenable to joining that Function, a value less than the maximum value is assigned to the Function score. However, if the candidate is not currently in that Function and does not wish to join that Function, the candidate is filtered out, and this particular matching process is terminated.

Experience Level. In an example, the score for Experience Level is determined, for job to candidate matching, based on the “job family” (or job title) and the “job function,” as shown in the example illustrated in FIG. 16K. As shown therein, if the job is for an executive assistant (the Job Family) in the administrative department (the Job Function), then the experience of the candidate as an executive assistant (EA), administrative assistant (AA), event planner, and data analyst can be properly accounted for. For example, the candidate's previous EA and AA experience will contribute fully toward the score for Experience Level, but only partially for the event planning experience, and not at all for the data analyst experience. The score for the Experience Level for candidate to job matching is similarly determined.

Title. In an example, the score for Title (the title of the job) is determined, for job to candidate matching, based on the title of the offered job, but accounting for the Job Family, as shown in FIG. 16L. As shown therein, if the previous and current title match, then a maximum value is assigned to the Title score. A first value (S1) less than the maximum value is assigned when the job title does not match, but the job family matches; and a second value (S2) less than the maximum value is assigned when both the job title and the job family do not match, but the job function matches. If none of the job title, job family, and job function match, then a zero value is assigned to the Title score.

Duties and Requirements. In an example, the score for Duties is determined, for job to candidate matching, based on the list of duties required by the offered position and the duties performed by the candidate in their previous job. For example, if there are 7 job duties, and the candidate matches only 5 of the job duties, then the value assigned to this Duties score is 5/7×100=71%. In an example, the minimum value assigned to the Duties Score is 14%, which corresponds to 1/7×100. A similar determination may be made for the Requirements score.

Recency. In an example, the score for Recency is determined, for job to candidate matching, as shown in FIG. 16M. As shown therein, the Recency score decreases as the time the candidate last performed the job, which she is applying for, increases.

Key Skills. In an example, the score for Key Skills is determined, for job to candidate matching, is based on the number of Key Skills (e.g., Excel, Quickbooks, Spanish, calendaring, etc.) that ae common between the skills required for the offered job and those the candidate honed during a previous job. In an example, the Key Skills is determined based on one or more of the Job Title, Job Function, and/or Job Family.

In some embodiments, both job to candidate matching and candidate to job matching have hard cutoffs, e.g., criterion that immediately disqualify a matching from being made. In an example, the Work Sponsorship criterion in job to candidate matching, discussed in the context of FIG. 16A. In another example, for job to candidate matching, hard cutoffs include the candidate status being “Actively Looking” and not being “Do Not Call”, the current “Employer Name” of the candidate cannot be the same as the client that the job is attached to, and the like. In the case of candidate to job matching, hard cutoffs include the job being Active or Open and the job being at least a partial match to the candidate's Job Function preferences.

As discussed earlier, a weighted sum of the scores (taking into account any hard cutoffs) can be computed are used to determine, in an unbiased manner, the match between the candidate and the work opportunity.

3.3 Timekeeping and Financial Features

Embodiments of the disclosed technology include modules and processes that support one or more financial features, and which can be integrated into the skills management and matching platform. In some embodiments, these modules and processes include:
Placement management module
   Placement account team tracking
   Guarantee date management
   Placement fall-off process
Timekeeping module
   Candidate time entry
   Client hours approval/rejection/commenting
   Meal break tracking
   Sick time application
   Holiday PTO automation
   Placement revenue and margin tracking
   Bonus, commission, expense reimbursements, and PTO transactions
Payroll processing module
   Customizable financial rules
   Sick time accruals
Invoicing module
   Purchase order (PO) consumption tracking
   Invoice import API connection to ERP
   Customizable invoice grouping
   Customizable invoice sending
   Automated invoicing on timesheets
   Option to attach backing sheets to invoices

4 Example embodiments of the disclosed technology

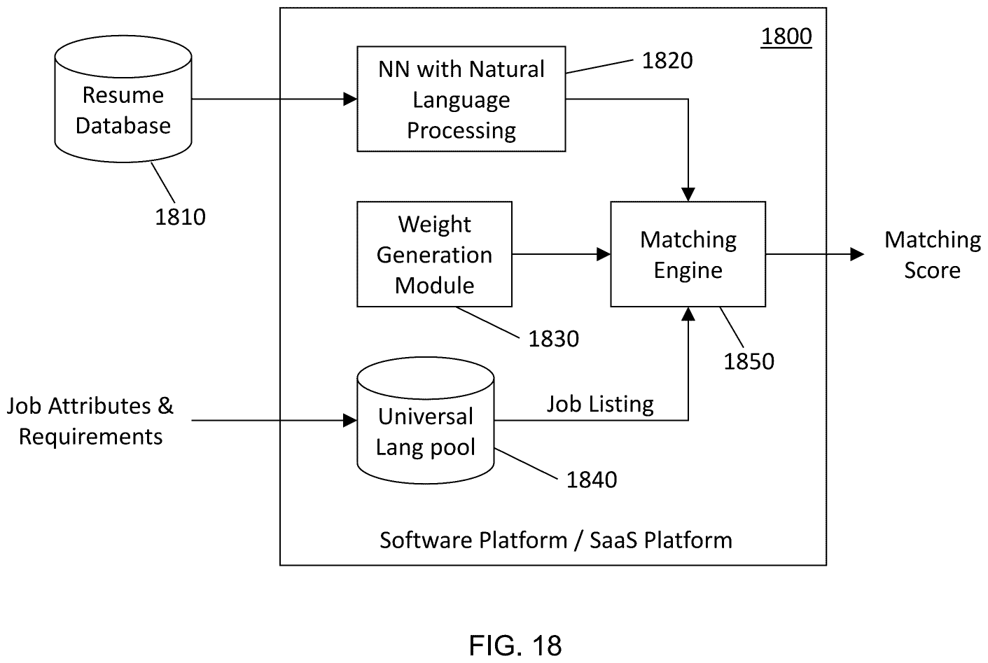

FIG. 18 is a block diagram illustrating an example of the functional architecture of the disclosed technology. As shown therein, the software platform (as described in Section 1) or the SaaS platform (as described in Section 2) includes a machine learning framework, e.g., a neural network with natural language processing (1820), that is configured to receive a candidate's resume from a resume database (1810), process the resume to extract skills and experiences reflective of the candidate's capabilities, and forward that to a matching engine (1850). The platform also includes a weight generation module (1830), which creates a set of weights (e.g., weights w1, w2, . . . , as described above) that are forwarded to the matching engine (1850), and a universal language pool (1840) of job title and job duties, which is used to create a job listing that is also forwarded to the matching engine (1850). The matching engine (1850) compares the candidate's skills and experiences to the job listing, computes a set of scores for each of the job requirements of the job listing, and outputs a matching score by created a weighted sum of the scores (using the weights from the weight generation module). In some embodiments, this functional architecture provides a technical solution to the skills management and matching problem that surpasses existing solutions.

Existing systems that use AI may assess candidates on something other than merit, and can raise legal and ethical concerns about transparency and data bias. Biased results may be produced by existing AI systems used for hiring and skills matching because they erroneously interpreting socioeconomic markers as indicative of success. In an example, in 2018, Amazon discarded an AI and machine-learning based recruitment program after it was found that the program was biased against women. Amazon's AI model was programmed to vet candidates by observing patterns in resumes submitted to the company over a 10-year period. The majority of those candidates had been men, which led the system to deduce that male candidates were preferred over female candidates.

Embodiments of the disclosed technology overcome the bias due to training data by, for example, gating (or redacting) information when a candidate is initially matched to a work opportunity, and by using the specific score methodologies of the matching process described in Section 3.2. These technical solutions described herein leverage the ability of AI to analyze information quicker than humans do (e.g., using a neural network and NLP to process resumes), but include safeguards (e.g., the universal language and the score-based matching operation) to ensure that biases that exist in current recruitment software are entirely eliminated.

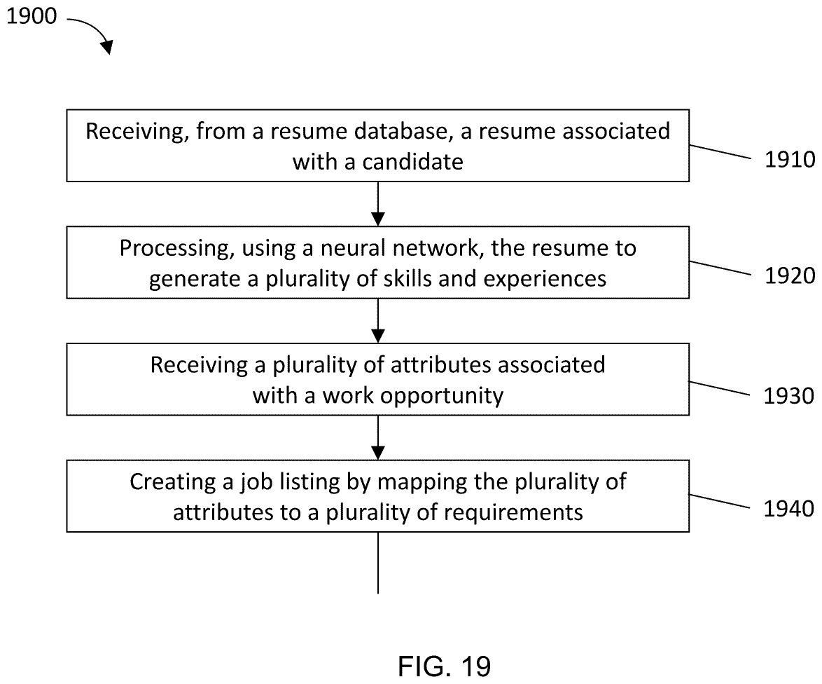

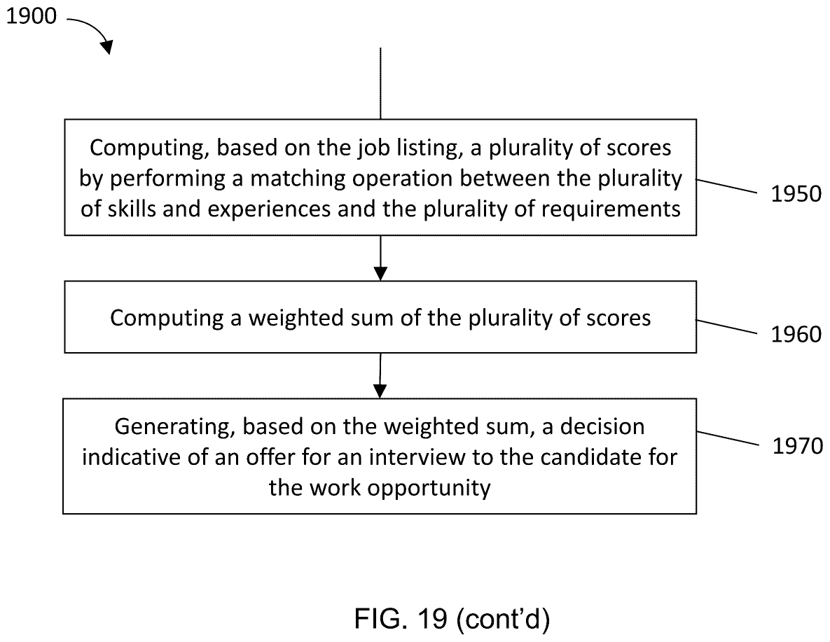

FIG. 19 is a flowchart of an example method 1900 for skills management and matching. As shown therein, the method 1900 includes the operations of receiving, from a resume database, a resume associated with a candidate (1910), processing, using a neural network, the resume to generate a plurality of skills and experiences (1920), receiving a plurality of attributes associated with a work opportunity (1930), creating a job listing by mapping the plurality of attributes to a plurality of requirements (1940), wherein each of the plurality of requirements is selected from a pool of job titles and job duties, computing, based on the job listing, a plurality of scores by performing a matching operation between the plurality of skills and experiences and the plurality of requirements (1950), computing a weighted sum of the plurality of scores (1960), and generating, based on the weighted sum, a decision indicative of an offer for an interview to the candidate for the work opportunity (1970).

Embodiments of the disclosed technology provide the following technical solutions:

1. A system for skills management and matching, comprising: a graphical user interface; a neural network comprising: an input that receives a resume associated with a candidate, wherein the neural network is configured to process the resume to extract a plurality of skills and experiences reflective of one or more capabilities of the candidate; a universal language processor comprising: an input that receives a plurality of attributes associated with a work opportunity, wherein the universal language processor is configured to create a job listing by mapping the plurality of attributes to a plurality of requirements, wherein each of the plurality of requirements is selected from a pool of job titles and job duties; a weight generation module configured to generate a plurality of weights; and a matching engine comprising: a first input, coupled to an output of the neural network, that receives the plurality of skills and experiences, a second input, coupled to an output of the weight generation module, that receives the plurality of weights, a third input, coupled to an output of the universal language processor, that receives the plurality of requirements, and an output, coupled to the graphical user interface, that outputs, for display on the graphical user interface, a decision to extend an offer for an interview to the candidate for the work opportunity, wherein the matching engine is configured to: compute a plurality of scores by performing a matching operation between the plurality of skills and experiences and the plurality of requirements, compute a weighted sum by multiplying each of the plurality of weights to a corresponding each of the plurality of scores, and generate, based on the weighted sum, the decision.

2. The system of solution 1, wherein the neural network comprises a natural language processing (NLP) module.

3. The system of solution 2, wherein the neural network is a recurrent neural network (RNN), and wherein the NLP module is configured to implement at least one of sentiment analysis, machine translation, named-entity recognition, stemming, lemmatization, topic modeling, keyword extraction, or a rule-based system.

4. The system of any of solutions 1 to 3, wherein the plurality of scores comprises an employment type score, a job type score, a compensation score, a proximity score, an experience level score, a key skill score, or a recency score.

5. The system of solution 4, wherein the employment type score is set to (a) a maximum value in response to a candidate employment type matching an employer employment type, or (b) another value less than the maximum value otherwise.

6. The system of solution 5, wherein the candidate employment type and the employer employment type is selected from the group consisting of permanent employment, contract to hire employment, and contract employment.

7. The system of solution 4, wherein the compensation score is based on (a) a minimum desired compensation of the candidate, (b) a maximum desired compensation of the candidate, (c) a minimum wage of the work opportunity, and (d) a maximum wage of the work opportunity.

8. The system of solution 7, wherein the compensation score is set to (a) a maximum value in response to the maximum desired compensation being less than the maximum wage and the minimum desired compensation being greater than the minimum wage, or (b) the maximum value in response to the maximum desired compensation being greater than the maximum wage and the minimum desired compensation being greater than the minimum wage, or (c) a first value less than the maximum value in response to the maximum desired compensation being greater than the minimum wage and the minimum desired compensation being less than the minimum wage, or (d) a second value less than the maximum value in response to the maximum desired compensation being greater than the maximum wage and the minimum desired compensation being less than the maximum wage, or (e) a third value less than the maximum value in response to both the maximum desired compensation and the minimum desired compensation being less than the minimum wage, the third value decreasing to zero when the maximum desired compensation is a factor of N1 times less than the minimum wage, and the third value decreasing at a first rate, or (f) a fourth value less than the maximum value in response to both the maximum desired compensation and the minimum desired compensation being greater than the maximum wage, the fourth value decreasing to zero when the minimum desired compensation is a factor of N2 times more than the maximum wage, and the fourth value decreasing at a second rate, wherein N1 and N2 are real numbers between 1.0 and 2.0, and wherein the second rate is greater than the first rate.

9. The system of solution 4, wherein the proximity score is based on a candidate location, a candidate proximity centered at the candidate location, a work opportunity location, and a work opportunity proximity centered at the work opportunity location.

10. The system of solution 9, wherein the proximity score is set to (a) a maximum value in response to a distance between the candidate location and the work opportunity location being within both the candidate proximity and the work opportunity proximity, or (b) a first value less than the maximum value in response to the work opportunity location being within the candidate proximity, and the first value decreasing to a second value as the work opportunity location nears an edge of the candidate proximity, or (c) the second value in response to an overlap between the candidate proximity and the work opportunity proximity being greater than zero, and the second value decreasing to zero as the overlap decreases to zero, or (d) a zero value in response to the overlap being zero.

11. The system of any of solutions 1 to 10, wherein information associated with at least one field of the resume is redacted prior to the interview being conducted.

12. The system of solution 11, wherein the information comprises at least one of a name of the candidate, a home address of the candidate, or an ethnicity of the candidate.

13. The system of any of solutions 1 to 12, wherein the resume is a video resume.

14. A method for skills management and matching, comprising: receiving, from a resume database, a resume associated with a candidate; processing, using a neural network, the resume to generate a plurality of skills and experiences; receiving a plurality of attributes associated with a work opportunity; creating a job listing by mapping the plurality of attributes to a plurality of requirements, wherein each of the plurality of requirements is selected from a pool of job titles and job duties; computing, based on the job listing, a plurality of scores by performing a matching operation between the plurality of skills and experiences and the plurality of requirements; computing a weighted sum of the plurality of scores; and generating, based on the weighted sum, a decision indicative of an offer for an interview to the candidate for the work opportunity.

15. The method of solution 14, wherein creating the job listing comprises: for at least one attribute of the plurality of attributes, processing, using a machine learning framework that implements natural language processing, the at least one attribute, identifying and removing a non-standard descriptor from the at least one attribute, and selecting a corresponding requirement by comparing the at least one attribute with the non-standard descriptor removed to one or more of the plurality of requirements.

16. The method of solution 14 or 15, wherein performing the matching operation comprises: for at least one skill and experience of the plurality of skills and experiences, comparing a type of the at least one skill or experience to a type of the corresponding requirement, wherein a corresponding score of the plurality of scores is based on the comparing.

17. The method of any of solutions 14 to 16, wherein the plurality of scores comprises an employment type score, a job type score, a compensation score, a proximity score, an experience level score, a key skill score, or a recency score.

18. The method of any of solutions 14 to 17, wherein the weighted sum is computed using a first set of weights in response to matching a candidate to a plurality of work opportunities, wherein the weighted sum is computed using a second set of weights in response to matching a work opportunity to a plurality of candidates.

19. The method of solution 18, wherein the first set of weights is different from the second set of weights.

20. A non-transitory computer-readable medium storing executable instructions that, when implemented by a processor, perform a method for skills management and matching, the method comprising: receiving, from a resume database, a resume associated with a candidate; processing, using a neural network, the resume to generate a plurality of skills and experiences; receiving a plurality of attributes associated with a work opportunity; creating a job listing by mapping the plurality of attributes to a plurality of requirements, wherein each of the plurality of requirements is selected from a pool of job titles and job duties; computing, based on the job listing, a plurality of scores by performing a matching operation between the plurality of skills and experiences and the plurality of requirements; computing a weighted sum of the plurality of scores; and generating, based on the weighted sum, a decision indicative of an offer for an interview to the candidate for the work opportunity.

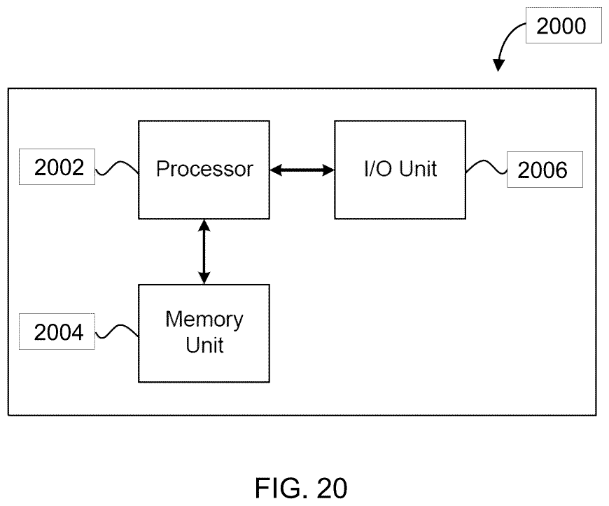

FIG. 20 shows a block diagram of an example embodiment of a device (or apparatus, hardware device or implementation) 2000 that implements the disclosed technology. The device includes a processor 2002 in communication with a memory unit 2004 and an input/output (I/O) unit 2006. The processor 2002 is configured to process data, and the memory unit 2004 is in communication with the processor to store and/or buffer the data. To support various functions of the device, the processor can be included to interface with and control operations of other devices, e.g., via the I/O unit 2006.

In various implementations, the processor 2002 can include one or more processors, e.g., including but not limited to microprocessors such as a central processing unit (CPU), microcontrollers, or the like. The memory unit 2004 can include and store processor-executable code, which when executed by the processor, configures the device to perform various operations, e.g., such as receiving information, commands, and/or data, processing information and data, and transmitting or providing information/data to another device. The memory unit can store other information and data, such as instructions, software, values, images, and other data processed or referenced by processor. For example, various types of Random Access Memory (RAM) devices, Read Only Memory (ROM) devices, Flash Memory devices, and other suitable storage media can be used to implement storage functions of memory unit. In some implementations, the device includes an input/output unit (I/O) 2006 to interface the processor and/or memory unit to other modules, units or devices associated with the system, and/or external devices. For example, the I/O unit can connect to an external interface, source of data storage, or display device. Various types of wired or wireless interfaces compatible with typical data communication standards, such as Universal Serial Bus (USB), IEEE 1394 (FireWire), Bluetooth, Bluetooth low energy (BLE), ZigBee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces, can be used to communicate data with the device via the I/O unit. In some implementations, for example, the device 2000 includes a wireless communications unit, e.g., such as a transmitter (Tx) or a transmitter/receiver (Tx/Rx) unit. In such implementations, for example, the I/O unit can interface the processor and memory unit with the wireless communications unit to utilize various types of wireless interfaces, such as the examples described above. The I/O unit can interface with other external interfaces, sources of data storage, and/or visual or audio display devices, etc. to retrieve and transfer data and information that can be processed by the processor, stored in the memory unit, or exhibited on an output unit of a user device (e.g., display screen of a computing device) or an external device.

It is understood that the various disclosed embodiments may be implemented individually, or collectively, in devices comprised of electronic components, hardware and/or software modules and components. These devices, for example, may comprise a processor, a memory unit, an interface that are communicatively connected to each other, and may range from desktop and/or laptop computers, to mobile devices and the like. The processor and/or controller can be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

While this document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A system for skills management and matching, comprising:
a graphical user interface;
a neural network comprising:
an input that receives a resume associated with a candidate,
wherein the neural network is configured to process the resume to extract a plurality of skills and experiences reflective of one or more capabilities of the candidate;
a universal language processor comprising:
an input that receives a plurality of attributes associated with a work opportunity,
wherein the universal language processor is configured to create a job listing by mapping the plurality of attributes to a plurality of requirements, wherein each of the plurality of requirements is selected from a pool of job titles and job duties;
a weight generation module configured to generate a plurality of weights; and
a matching engine comprising:
a first input, coupled to an output of the neural network, that receives the plurality of skills and experiences,
a second input, coupled to an output of the weight generation module, that receives the plurality of weights,
a third input, coupled to an output of the universal language processor, that receives the plurality of requirements, and
an output, coupled to the graphical user interface, that outputs, for display on the graphical user interface, a decision to extend an offer for an interview to the candidate for the work opportunity,
wherein the matching engine is configured to:
compute a plurality of scores by performing a matching operation between the plurality of skills and experiences and the plurality of requirements,
compute a weighted sum by multiplying each of the plurality of weights to a corresponding each of the plurality of scores, and
generate, based on the weighted sum, the decision.

2. The system of claim 1, wherein the neural network comprises a natural language processing (NLP) module.

3. The system of claim 2, wherein the neural network is a recurrent neural network (RNN), and wherein the NLP module is configured to implement at least one of sentiment analysis, machine translation, named-entity recognition, stemming, lemmatization, topic modeling, keyword extraction, or a rule-based system.

4. The system of claim 1, wherein the plurality of scores comprises an employment type score, a job type score, a compensation score, a proximity score, an experience level score, a key skill score, or a recency score.

5. The system of claim 4, wherein the employment type score is set to
(a) a maximum value in response to a candidate employment type matching an employer employment type, or
(b) another value less than the maximum value otherwise.

6. The system of claim 5, wherein the candidate employment type and the employer employment type is selected from the group consisting of permanent employment, contract to hire employment, and contract employment.

7. The system of claim 4, wherein the compensation score is based on (a) a minimum desired compensation of the candidate, (b) a maximum desired compensation of the candidate, (c) a minimum wage of the work opportunity, and (d) a maximum wage of the work opportunity.

8. The system of claim 7, wherein the compensation score is set to
(a) a maximum value in response to the maximum desired compensation being less than the maximum wage and the minimum desired compensation being greater than the minimum wage, or
(b) the maximum value in response to the maximum desired compensation being greater than the maximum wage and the minimum desired compensation being greater than the minimum wage, or
(c) a first value less than the maximum value in response to the maximum desired compensation being greater than the minimum wage and the minimum desired compensation being less than the minimum wage, or
(d) a second value less than the maximum value in response to the maximum desired compensation being greater than the maximum wage and the minimum desired compensation being less than the maximum wage, or
(e) a third value less than the maximum value in response to both the maximum desired compensation and the minimum desired compensation being less than the minimum wage, the third value decreasing to zero when the maximum desired compensation is a factor of N1 times less than the minimum wage, and the third value decreasing at a first rate, or
(f) a fourth value less than the maximum value in response to both the maximum desired compensation and the minimum desired compensation being greater than the maximum wage, the fourth value decreasing to zero when the minimum desired compensation is a factor of N2 times more than the maximum wage, and the fourth value decreasing at a second rate,
wherein N1 and N2 are real numbers between 1.0 and 2.0, and
wherein the second rate is greater than the first rate.

9. The system of claim 4, wherein the proximity score is based on a candidate location, a candidate proximity centered at the candidate location, a work opportunity location, and a work opportunity proximity centered at the work opportunity location.

10. The system of claim 9, wherein the proximity score is set to
(a) a maximum value in response to a distance between the candidate location and the work opportunity location being within both the candidate proximity and the work opportunity proximity, or
(b) a first value less than the maximum value in response to the work opportunity location being within the candidate proximity, and the first value decreasing to a second value as the work opportunity location nears an edge of the candidate proximity, or
(c) the second value in response to an overlap between the candidate proximity and the work opportunity proximity being greater than zero, and the second value decreasing to zero as the overlap decreases to zero, or
(d) a zero value in response to the overlap being zero.

11. The system of claim 1, wherein information associated with at least one field of the resume is redacted prior to the interview being conducted.

12. The system of claim 11, wherein the information comprises at least one of a name of the candidate, a home address of the candidate, or an ethnicity of the candidate.

13. The system of claim 1, wherein the resume is a video resume.

14. A method for skills management and matching, comprising:
receiving, from a resume database, a resume associated with a candidate;
processing, using a neural network, the resume to generate a plurality of skills and experiences;
receiving a plurality of attributes associated with a work opportunity;
creating a job listing by mapping the plurality of attributes to a plurality of requirements, wherein each of the plurality of requirements is selected from a pool of job titles and job duties;
computing, based on the job listing, a plurality of scores by performing a matching operation between the plurality of skills and experiences and the plurality of requirements;
computing a weighted sum of the plurality of scores; and
generating, based on the weighted sum, a decision indicative of an offer for an interview to the candidate for the work opportunity.

15. The method of claim 14, wherein creating the job listing comprises:
for at least one attribute of the plurality of attributes,
processing, using a machine learning framework that implements natural language processing, the at least one attribute,
identifying and removing a non-standard descriptor from the at least one attribute, and
selecting a corresponding requirement by comparing the at least one attribute with the non-standard descriptor removed to one or more of the plurality of requirements.

16. The method of claim 14, wherein performing the matching operation comprises:
for at least one skill and experience of the plurality of skills and experiences,
comparing a type of the at least one skill or experience to a type of the corresponding requirement, wherein a corresponding score of the plurality of scores is based on the comparing.

17. The method of claim 14, wherein the plurality of scores comprises an employment type score, a job type score, a compensation score, a proximity score, an experience level score, a key skill score, or a recency score.

18. The method of claim 14, wherein the weighted sum is computed using a first set of weights in response to matching a candidate to a plurality of work opportunities, wherein the weighted sum is computed using a second set of weights in response to matching a work opportunity to a plurality of candidates.

19. The method of claim 18, wherein the first set of weights is different from the second set of weights.

20. A non-transitory computer-readable medium storing executable instructions that, when implemented by a processor, perform a method for skills management and matching, the method comprising:
receiving, from a resume database, a resume associated with a candidate;
processing, using a neural network, the resume to generate a plurality of skills and experiences;
receiving a plurality of attributes associated with a work opportunity;
creating a job listing by mapping the plurality of attributes to a plurality of requirements, wherein each of the plurality of requirements is selected from a pool of job titles and job duties;
computing, based on the job listing, a plurality of scores by performing a matching operation between the plurality of skills and experiences and the plurality of requirements;
computing a weighted sum of the plurality of scores; and
generating, based on the weighted sum, a decision indicative of an offer for an interview to the candidate for the work opportunity.
